(19) United States
(12) Patent Application Publication
(10) Pub. No.: US 2026/0231188 A1
(43) Pub. Date: Aug. 6, 2026

(54) TECHNIQUES FOR MANAGING ADJACENT CHANNEL COEXISTENCE FOR DIFFERENT RADIO ACCESS TECHNOLOGIES

(71) Applicant: QUALCOMM Incorporated, San Diego, CA (US)

(72) Inventors: Hui GUO, Beijing (CN); Tien Viet NGUYEN, Bridgewater, NJ (US); Shailesh PATIL, San Diego, CA (US); Gene Wesley MARSH, San Diego, CA (US); Sean Vincent MASCHUE, Encinitas, CA (US); Kapil GULATI, Belle Mead, NJ (US); Shuanshuan WU, San Diego, CA (US)

(21) Appl. No.: 19/155,192

(22) PCT Filed: Mar. 15, 2023
(86) PCT No.: PCT/CN2023/081518

§ 371 Date: Aug. 8, 2025

(51) Int. Cl. H04W 72/25; H04W 72/0446

(52) U.S. Cl. CPC H04W 72/25; H04W 72/0446

(57) ABSTRACT

Methods, systems, and devices for wireless communication are described. A user equipment (UE) may receive, at a first radio access technology (RAT) modem of the UE, sidelink control information (SCI) indicative of a set of parameters and a set of time resources reserved for receipt of a packet via a first RAT associated with the first RAT modem of the UE. The UE may output, from a first RAT modem of the UE to a second RAT modem of the UE, information indicative of a set of parameters and a set of time resources reserved for receipt of a packet via the first RAT associated with the first RAT modem. The UE may refrain from communicating using the second RAT modem of the UE on the set of time resources based on the information indicative of the set of parameters and the set of time resources.

### CROSS REFERENCE

The present Application is a 371 national phase filing of International PCT Application No. PCT/CN2023/081518 by GUO et al., entitled “TECHNIQUES FOR MANAGING ADJACENT CHANNEL COEXISTENCE FOR DIFFERENT RADIO ACCESS TECHNOLOGIES,” filed Mar. 15, 2023, which is assigned to the assignee hereof, and which is expressly incorporated by reference in its entirety herein.

### INTRODUCTION

The following relates to wireless communication, including techniques for managing coexistence for radio access technologies (RATs). Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a first UE is described. The method may include receiving, at a first RAT modem of the first UE, sidelink control information (SCI) indicative of a set of parameters and a set of time resources reserved for receipt of at least one packet from one or more second UEs via a first RAT associated with the first RAT modem of the first UE, outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT, refraining, at the first UE, from communicating using the second RAT modem of the first UE during the set of time resources based on the information indicative of the set of parameters and the set of time resources, and receiving, via the first RAT and using the first RAT modem, the at least one packet using one or more parameters of the set of parameters and one or more resources of the set of time resources.

An apparatus for wireless communication at a first UE is described. The apparatus may include a processor, and memory coupled with the processor, the processor configured to receive, at a first RAT modem of the first UE, SCI indicative of a set of parameters and a set of time resources reserved for receipt of at least one packet from one or more second UEs via a first RAT associated with the first RAT modem of the first UE, outputting, from the first RAT modem of the first UE to a second RAT modem of the first UE, information indicative of the set of parameters and the set of time resources re-serve for receipt of the at least one packet from the one or more second UEs via the first RAT associated with the first RAT modem, the second RAT modem being associated with a second RAT different from the first RAT, refrain, at the first UE, from communicating using the second RAT modem of the first UE during the set of time resources based on the information indicative of the set of parameters and the set of time resources, and receive, via the first RAT and using the first RAT modem, the at least one packet using one or more parameters of the set of parameters and one or more resources of the set of time resources.

Another apparatus for wireless communication at a first UE is described. The apparatus may include means for receiving, at a first RAT modem of the first UE, SCI indicative of a set of parameters and a set of time resources reserved for receipt of at least one packet from one or more second UEs via a first RAT associated with the first RAT modem of the first UE, means for outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT, means for refraining, at the first UE, from communicating using the second RAT modem of the first UE during the set of time resources based on the information indicative of the set of parameters and the set of time resources, and means for receiving, via the first RAT and using the first RAT modem, the at least one packet using one or more parameters of the set of parameters and one or more resources of the set of time resources.

A non-transitory computer-readable medium storing code for wireless communication at a first UE is described. The code may include instructions executable by a processor to receive, at a first RAT modem of the first UE, SCI indicative of a set of parameters and a set of time resources reserved for receipt of at least one packet from one or more second UEs via a first RAT associated with the first RAT modem of the first UE, outputting, from the first RAT modem of the first UE to a second RAT modem of the first UE, information indicative of the set of parameters and the set of time resources re-serve for receipt of the at least one packet from the one or more second UEs via the first RAT associated with the first RAT modem, the second RAT modem being associated with a second RAT different from the first RAT, refrain, at the first UE, from communicating using the second RAT modem of the first UE during the set of time resources based on the information indicative of the set of parameters and the set of time resources, and receive, via the first RAT and using the first RAT modem, the at least one packet using one or more parameters of the set of parameters and one or more resources of the set of time resources.

Some examples of the method, apparatuses, and non-transitory computer-readable medium described herein may further include operations, features, means, or instructions for refraining from communicating using the second RAT modem of the first UE during the set of time resources may be based on an overlap between a first time resource reserved for the first RAT associated with the first RAT modem and a second time resource reserved for the second RAT associated with the second RAT modem.

Some examples of the method, apparatuses, and non-transitory computer-readable medium described herein may further include operations, features, means, or instructions for determining the set of time resources reserved for receipt of the at least one packet from the one or more second UEs via the first RAT associated with the first RAT modem based on the SCI.

Some examples of the method, apparatuses, and non-transitory computer-readable medium described herein may further include operations, features, means, or instructions for generating a data structure indicative of the set of time resources reserved for receipt of the at least one packet from the one or more second UEs via the first RAT associated with the first RAT modem, where the information indicative of the set of time resources includes the data structure.

In some examples of the method, apparatuses, and non-transitory computer-readable medium described herein, the SCI includes first SCI or second SCI and outputting the information indicative of the set of time resources reserved for receipt of the at least one packet from the one or more second UEs via the first RAT associated with the first RAT modem may be based on one of the first SCI or the second SCI.

In some examples of the method, apparatuses, and non-transitory computer-readable medium described herein, receiving the SCI may include operations, features, means, or instructions for receiving first SCI over a physical sidelink control channel, the method further including, identifying reservation information based on the first SCI, and determining the set of time resources reserved for receipt of the at least one packet from the one or more second UEs via the first RAT associated with the first RAT modem based on the reservation information.

Some examples of the method, apparatuses, and non-transitory computer-readable medium described herein may further include operations, features, means, or instructions for receiving second SCI over a physical sidelink shared channel, identifying a layer one identifier based on the second SCI, where the layer one identifier includes a source layer one identifier or a destination layer one identifier, and determining to receive the at least one packet from the one or more second UEs via the first RAT associated with the first RAT modem based on the layer one identifier.

Some examples of the method, apparatuses, and non-transitory computer-readable medium described herein may further include operations, features, means, or instructions for determining a period indicative of a physical sidelink feedback channel reception at the one or more second UEs or one or more third UEs, outputting, from the first RAT modem of the first UE to the second RAT modem of the first UE, second information indicative of the period indicative of the physical sidelink feedback channel reception at the one or more second UEs or the one or more third UEs, and managing a channel access assessment based on the second information, where managing the channel access assessment includes terminating or pausing the channel access assessment.

Some examples of the method, apparatuses, and non-transitory computer-readable medium described herein may further include operations, features, means, or instructions for identifying the one or more second UEs or the one or more third UEs based on zone information indicating one or more zones associated with the one or more second UEs or the one or more third UEs.

Some examples of the method, apparatuses, and non-transitory computer-readable medium described herein may further include operations, features, means, or instructions for determining a pending physical sidelink feedback channel reception at the first UE based on one of first SCI or second SCI and managing a channel access assessment based on the pending physical sidelink feedback channel reception, where managing the channel access assessment includes terminating or pausing the channel access assessment.

Some examples of the method, apparatuses, and non-transitory computer-readable medium described herein may further include operations, features, means, or instructions for determining a priority associated with the at least one packet and determining the set of time resources reserved for receipt of the at least one packet from the one or more second UEs via the first RAT associated with the first RAT modem based on the priority associated with the at least one packet, and where the set of time resources may be based on the priority associated with the at least one packet satisfying a threshold.

In some examples of the method, apparatuses, and non-transitory computer-readable medium described herein, the SCI includes first SCI indicating the priority associated with the at least one packet.

Some examples of the method, apparatuses, and non-transitory computer-readable medium described herein may further include operations, features, means, or instructions for measuring a reference signal received power value associated with the at least one packet and determining the set of time resources reserved for receipt of the at least one packet from the one or more second UEs via the first RAT associated with the first RAT modem based on the reference signal received power value associated with the at least one packet.

Some examples of the method, apparatuses, and non-transitory computer-readable medium described herein may further include operations, features, means, or instructions for transmitting feedback associated with the at least one packet based on a decoding result associated with the at least one packet and determining a second set of time resources reserved for receipt of the at least one packet from the one or more second UEs via the first RAT associated with the first RAT modem based on the decoding result associated with the at least one packet.

In some examples of the method, apparatuses, and non-transitory computer-readable medium described herein, the information includes a command for the second RAT modem of the first UE to pause performing a channel access assessment for a duration of time based on a priority associated with the at least one packet.

In some examples of the method, apparatuses, and non-transitory computer-readable medium described herein, the information includes a command for the second RAT modem of the first UE to terminate a channel access assessment based on a priority associated with the at least one packet.

In some examples of the method, apparatuses, and non-transitory computer-readable medium described herein, the information indicative of the set of time resources reserved for receipt of the at least one packet from the one or more second UEs via the first RAT associated with the first RAT modem may be further indicative of one or more time resources reserved for receipt of a sidelink feedback message over a physical sidelink feedback channel via the first RAT associated with the first RAT modem.

In some examples of the method, apparatuses, and non-transitory computer-readable medium described herein, the information indicative of the set of time resources reserved for receipt of the at least one packet from the one or more second UEs via the first RAT associated with the first RAT modem may be further indicative of a feedback mode associated with the first UE.

Some examples of the method, apparatuses, and non-transitory computer-readable medium described herein may further include operations, features, means, or instructions for receiving an inter-UE coordination message including second information indicative of a second set of time resources reserved by at least one second UE of the one or more second UEs, outputting, from the first RAT modem of the first UE to the second RAT modem of the first UE, third information indicative of the second set of time resources reserved by the at least one second UE of the one or more second UEs, and managing a channel access assessment based on the third information, where managing the channel access assessment includes terminating or pausing the channel access assessment.

Some examples of the method, apparatuses, and non-transitory computer-readable medium described herein may further include operations, features, means, or instructions for measuring a reference signal received power value associated with the inter-UE coordination message and where outputting, from the first RAT modem of the first UE to the second RAT modem of the first UE, the third information indicative of the second set of time resources reserved by the at least one second UE of the one or more second UEs may be based on the reference signal received power value associated with the inter-UE coordination message satisfying a threshold.

In some examples of the method, apparatuses, and non-transitory computer-readable medium described herein, the set of time resources includes one or more slots.

In some examples of the method, apparatuses, and non-transitory computer-readable medium described herein, the set of parameters includes one or more of a priority associated with the at least one packet, a physical layer configuration associated with one or both of the first RAT modem of the first UE or the second RAT modem of the first UE, zone information associated with the one or more second UEs including one or more zone identifiers associated with each of the one or more second UEs, a threshold communication range associated with one or both of the first RAT modem of the first UE or the second RAT modem of the first UE, or a reference signal received power (RSRP) associated with the at least one packet.

In some examples of the method, apparatuses, and non-transitory computer-readable medium described herein, the first RAT includes a Long-Term Evolution (LTE) RAT, a Fourth Generation (4G) RAT, a Fifth Generation (5G) RAT, a New Radio (NR) access technology, a Sixth Generation RAT, or any combination thereof and the second RAT includes a Wi-Fi RAT, a dedicated short range communication (DSRC) RAT, or both.

In some examples of the method, apparatuses, and non-transitory computer-readable medium described herein, the first RAT includes a Long Term Evolution vehicle-to-everything (LTE-V2X) RAT, a New Radio vehicle-to-everything (NR-V2X) RAT, or both.

### BRIEF DESCRIPTION OF THE DRAWINGS

FIG. 1 illustrates an example of a wireless communications system that supports techniques for managing adjacent channel coexistence for different RATs in accordance with one or more aspects of the present disclosure.

FIG. 2 illustrates an example of a network architecture that supports techniques for managing adjacent channel coexistence for different RATs in accordance with one or more aspects of the present disclosure.

FIG. 3 illustrates an example of a wireless communications system that supports techniques for managing adjacent channel coexistence for different RATs in accordance with one or more aspects of the present disclosure.

FIG. 4 illustrates an example of a block diagram of an radio frequency front end (RFFE) radio module (e.g., 3rd Generation Partnership Project (3GPP) system-on-a-chip (SOC) for second generation (2G) through 6G communications, wide area network (WAN) RF, V2X digital-to-analog converter (DAC), etc.) that supports techniques for managing adjacent channel coexistence for different RATs in accordance with one or more aspects of the present disclosure.

FIG. 5 illustrates an example of a resource configuration that supports techniques for managing adjacent channel coexistence for different RATs in accordance with one or more aspects of the present disclosure.

FIG. 6 illustrates an example of a process flow that supports techniques for managing adjacent channel coexistence for different RATs in accordance with one or more aspects of the present disclosure.

FIGS. 7 and 8 illustrate block diagrams of devices that support techniques for managing adjacent channel coexistence for different RATs in accordance with one or more aspects of the present disclosure.

FIG. 9 illustrates a block diagram of a communications manager that supports techniques for managing adjacent channel coexistence for different RATs in accordance with one or more aspects of the present disclosure.

FIG. 10 illustrates a diagram of a system including a device that supports techniques for managing adjacent channel coexistence for different RATs in accordance with one or more aspects of the present disclosure.

FIGS. 11 through 14 illustrate flowcharts showing methods that support techniques for managing adjacent channel coexistence for different RATs in accordance with one or more aspects of the present disclosure.

### DETAILED DESCRIPTION

A communication device, for example, a UE may be configured (e.g., equipped) with multiple radios to support wireless communication (e.g., uplink transmission, downlink reception, sidelink transmission, sidelink reception) via multiple RATs. Examples of RATs include LTE, NR, wireless local area network (WLAN), dedicated short range communication (DSRC), etc. In some cases, the communication device may be equipped with at least two radios, each radio including a modem supporting a different radio access technology (RATs). A first radio may include a first RAT modem for cellular communication (e.g., LTE vehicle-to-everything (V2X) communications, NR-V2X communications, or other RATs beyond 5G). A second radio may include a second RAT modem for non-cellular communication (e.g., WLAN communication, including Wi-Fi communication, DSRC communications, or other 802.11p RATs). The UE may be deployed within a wireless communication system (e.g., a V2X system), in which multiple RATs operate across one or multiple channels (e.g., frequency resources), which may be adjacent (e.g., contiguous, consecutive) in a frequency domain. By way of example, the first RAT modem for the cellular communication may operate across a 20 MHz of a channel, while the second RAT modem for the non-cellular communication may operate across 10 MHz of the channel adjacent to the 20 MHz.

In some cases, the UE may experience channel coexistence interference that may degrade a reliability of the wireless communication (e.g., uplink transmission, downlink reception, sidelink transmission, sidelink reception) associated with the multiple RATs. For example, the UE may communicate messages (e.g., traffic information) via the first RAT modem associated with the cellular communication and packets (e.g., basic safety messages (BSM) packets, co-operative awareness messages (CAM)) via the second RAT modem associated with the non-cellular communication. The UE may experience saturation of a transmitter radio frequency (RF) chain or a receiver RF chain of the RAT modems. For example, when the first RAT modem is performing a transmission, the transmission may saturate a receiver RF chain of the second RAT modem (e.g., distort the receiver RF chain of the second RAT modem). As such, any reception attempt at the second RAT modem may be unsuccessful. Additionally, the transmission may cause interference to other receiver RF chains associated with other communication devices, for example, other UEs that are within a proximity to the UE.

Various aspects of the present disclosure relate to techniques for managing a channel coexistence interference, and more specifically to reducing or mitigating channel coexistence interference between multiple RATs supported at a UE (e.g., a UE equipped with multiple radios supporting different RATs). For example, a UE may be configured to support wireless communication via a first RAT modem and a second RAT modem. In this example, the UE may receive, at a first RAT modem of the UE, sidelink control information (SCI) indicative of a set of parameters and a set of time resources (e.g., one or more slots) reserved for receipt of at least one transmission (e.g., sidelink data, sidelink feedback) from one or more other communication device (e.g., other UEs) via the first RAT modem. The set of parameters may include a priority associated with the at least one transmission, a physical layer configuration associated with one or both of the first RAT modem of the UE or the second RAT modem of the UE, or a reference signal received power (RSRP) associated with the transmission, among other examples as described herein.

The UE may output, from the first RAT modem to the second RAT modem, information indicative of the set of parameters and the set of time resources reserved for receipt of the at least one transmission (e.g., sidelink data, sidelink feedback). By outputting the information (e.g., parameters, time resources reserved for receipt of a transmission (e.g., sidelink data, sidelink feedback)) between the first RAT modem and the second RAT modem, the UE may refrain from communicating (e.g., transmitting, receiving) using the second RAT modem during the set of time resources, and receive, via the first RAT modem the transmission (e.g., sidelink data, sidelink feedback) using one or more parameters of the set of parameters and one or more resources of the set of time resources. Additionally, by enabling the UE to support exchange of information (e.g., parameters, time resources reserved for receipt of a transmission (e.g., sidelink data, sidelink feedback)) between the first RAT modem and the second RAT modem, the UE may experience reduced or eliminated channel coexistence interference (e.g., in-device coexistence interference) between the first RAT modem and the second RAT modem of the UE.

For the purposes of the present disclosure, the term “modem” may refer to a component of a wireless device that is used to modulate and/or demodulate analog signals communicated by the wireless device. Moreover, as it is used herein, the term “coordination message” may refer to messages or information exchanged between different modems of a wireless device that are associated with different RATs. In other words, the terms “coordination message” and “coordination information” may refer to messages/information that is exchanged between different components of a same wireless device to coordinate communications across different RATs.

Aspects of the disclosure are initially described in the context of wireless communications systems. Aspects of the disclosure are further described in the context of an example network architecture, an example RFFE radio module, an example resource configuration, and an example process flow. Aspects of the disclosure are further illustrated by and described with reference to apparatus diagrams, system diagrams, and flowcharts that relate to techniques for managing adjacent channel coexistence for different RATs.

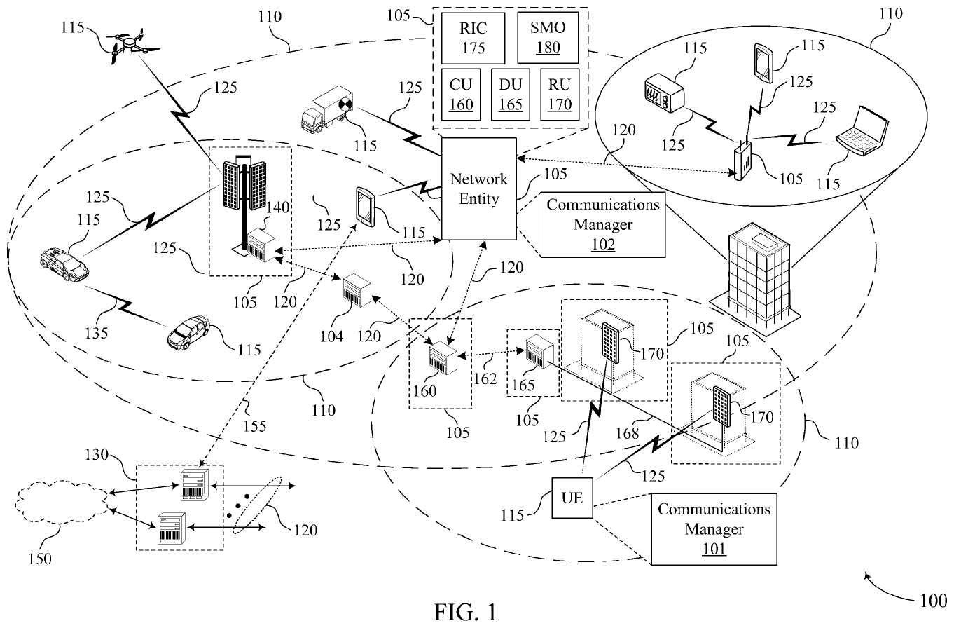

FIG. 1 illustrates an example of a wireless communications system 100 that supports techniques for managing adjacent channel coexistence for different RATs in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature, and may include a communications manager 102. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs using a communications manager 101.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for managing adjacent channel coexistence for different RATs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

Techniques described herein, in addition to or as an alternative to be carried out between UEs 115 and base stations 140, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 140 may include CUs 160, DUs 165, and RUs 170 and may be referred to as donor base stations 140 or IAB donors. One or more DUs 165 (e.g., and/or RUs 170) associated with a donor base station 140 may be partially controlled by CUs 160 associated with the donor base station 140. The one or more donor base stations 140 (e.g., IAB donors) may be in communication with one or more additional base stations 140 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 140. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 140 may additionally or alternatively be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communication system 100, a UE 115 may be configured (e.g., equipped) with multiple radios to support wireless communication (e.g., sidelink transmission, sidelink reception) via multiple RATs. In some cases, the UE 115 may be equipped with two radios (also referred to as a dual-radio), each radio including a modem supporting a different RAT. For example, a first radio of the UE 115 may include a first RAT modem associated with a first RAT (e.g., LTE-V2X, NR-V2X, or other RATs beyond 5G) and a second radio of the UE 115 may include a second RAT modem associated with a second RAT (e.g., Wi-Fi, DSRC, or other 802.11p RATs). A UE 115 configured (e.g., equipped) with multiple radios supporting different RATs may be referred to as a dual-radio UE, which may support signaling between baseband components and modems associated with RATs of the dual-radio UE.

In some cases, a first RAT (e.g., LTE-V2X, NR-V2X, or other RATs beyond 5G) and a second RAT (e.g., Wi-Fi, DSRC, or other 802.11p RATs) may operate in adjacent (e.g., contiguous, consecutive) channels or radio frequency spectrum bands. For example, a UE 115 may perform wireless communication (e.g., transmit, receive) associated with LTE-V2X, NR-V2X, or other RATs beyond 5G, on a first channel spanning between 5875-5895 MHz. Additionally, the UE 115 may perform wireless communication (e.g., transmit, receive) associated with Wi-Fi, DSRC, or other 802.11p RATs on a second channel spanning between 5895-5905 MHz.

Because the UE 115 may perform wireless communication (e.g., transmit or receive information, such as packets, control information, data) simultaneously (e.g., at the same time or relatively at the same time) on the first channel and the second channel, and because the first channel and the second channel are adjacent to each other in a frequency domain, the UE 115 may experience channel coexistence interference. The channel coexistence interference may degrade a reliability of the wireless communication (e.g., information, such as packets, control information, data) for on each of the respective RAT (e.g., LTE-V2X, NR-V2X, Wi-Fi, DSRC, or other RATs). Put another way, transmission or reception of information via the first RAT (e.g., LTE-V2X, NR-V2X, or other RATs beyond 5G) and transmission or reception of information via the second RAT (e.g., Wi-Fi, DSRC, or other 802.11p RATs), at the same time and on adjacent (e.g., contiguous, consecutive) channels or radio frequency spectrum bands (e.g., 5875-5895 MHz, 5895-5905 MHz) using the first RAT modem and the second RAT modem of the UE 115 may cause interference to the first RAT modem or the second RAT modem of the UE 115, or both.

In some cases, wireless communication via a RAT may be contention-based. For example, the second RAT (e.g., Wi-Fi, DSRC, or other 802.11p RATs) may be contention-based. The UE 115 may support a carrier-sense multiple access procedure, in which the UE 115 senses a channel before performing the wireless communication associated with Wi-Fi, DSRC, or other 802.11p RATs. In some examples, the wireless communication associated with Wi-Fi, DSRC, or other 802.11p RATs may be dynamic. In some other examples, the wireless communication associated with Wi-Fi, DSRC, or other RATs may be aperiodic. In other examples, the wireless communication associated with Wi-Fi, DSRC, or other 802.11p RATs may be random.

In contrast, wireless communication associated with LTE-V2X, NR-V2X, or other RATs beyond 5G may be predictable. For example, when data traffic (e.g., packets, control information, data) is periodic, semi-persistent scheduling (SPS) reservation for an initial transmission and a retransmission can be used to determine resources (e.g., time and/or frequency resources) for wireless communication associated with LTE-V2X, NR-V2X, or other RATs beyond 5G. Additionally, for aperiodic data traffic, (e.g., time and/or frequency resources) for a retransmission may be reserved prior to performing the wireless communication associated with LTE-V2X, NR-V2X, or other RATs beyond 5G.

For wireless communication associated with NR-V2X, the UE 115 may be configured to perform channel sensing (e.g., sidelink sensing) to determine whether sidelink resources are available for the wireless communication (also referred to as sidelink communication for NR-V2X deployment). When performing the channel sensing, the UE 115 may perform measurements (e.g., measure one or more reference signal received power (RSRP) values) within a sensing window of size To, where To may be configured by a network entity 105, and may be between 100 ms and 1100 ms, for example. The performed measurements (e.g., the one or more measured RSRP values) during the sensing window may be projected onto reservations within a future resource selection window. That is, performed measurements during the sensing window may be used to determine whether resources are available for use within a future time interval (e.g., one or more future slots). The UE 115 may compare the performed measurements (e.g., the one or more measured RSRP values) within the selection window with a threshold, and may increase the threshold until a configurable percentage of resources have measurements (e.g., one or more RSRP values) below the respective threshold.

Comparatively, for wireless communication associated with DSRC, Wi-Fi, or other 802.11p RATs, the UE 115 may perform and/or manage a channel access operation (e.g., a listen before talk (LBT), a clear channel assessment (CCA) (also referred to as channel access assessment (CCA)) to determine whether resources are available for the wireless communication. The UE 115 may perform the channel access operation (e.g., LBT, CCA) by performing measurements for a channel (e.g., uplink channel, sidelink channel). If the UE 115 determines that the channel is unoccupied (e.g., not being used) based on measurements (e.g., RSRP measurements) being less than a threshold (e.g., RSRP threshold), the UE 115 may determine that the channel is available, and may therefore reserve resources for the wireless communications performed over the channel. Conversely, if the UE 115 determines that the channel is occupied (e.g., being used) based on the measurements (e.g., RSRP measurements) being greater than the threshold (e.g., RSRP threshold), the UE 115 may determine that the channel is busy, and may delay repeating the channel access operation for a back-off time interval in order to avoid collisions.

For wireless communication associated with NR-V2X, the UE 115 may be configured to perform a feedback-based retransmission. For example, when a transmission associated NR-V2X (e.g., NR-V2X reception) is interfered at the UE 115 by another transmission associated with DSRC, for example, the UE 115 may trigger a feedback (e.g., a negative acknowledgment (NACK)), such that a retransmission (e.g., a repeat of the transmission associated NR-V2X) occurs. This feedback-based retransmission may result in increased number of retransmissions associated with NR-V2X to the UE 115 resulting in an increased interference to other transmission(s) associated with DSRC (e.g., DSRC reception) at the UE 115. As such, the second RAT modem of the UE 115 associated with the second RAT (e.g., Wi-Fi, DSRC, or other 802.11p RATs) may reduce interference at the second RAT modem by decreasing or mitigating interference to the first RAT modem of the UE 115 associated with the first RAT (e.g., LTE-V2X, NR-V2X, or other RATs beyond 5G).

A UE 115 may include a communication manager 101 configured to facilitate communications with the respective devices (e.g., network entities 105, UEs 115) of the wireless communications system 100. A UE 115 configured with the communication manager 101 may receive, at a first RAT modem of the UE 115, SCI indicative of a set of parameters and a set of time resources (e.g., one or more slots) reserved for receipt of at least one transmission (e.g., sidelink data, sidelink feedback) from one or more other communication device (e.g., other UEs) via the first RAT modem associated with the first RAT (e.g., LTE-V2X, NR-V2X, or other RATs beyond 5G). The set of parameter may include a priority associated with the at least one transmission, a physical layer configuration associated with one or both of the first RAT modem of the UE 115 or a second RAT modem of the UE 115, or a RSRP associated with the transmission, among other examples as described herein.

The communication manager 101 may output, from the first RAT modem to the second RAT modem associated with a second RAT (e.g., Wi-Fi, DSRC, or other 802.11p RATs), information indicative of the set of parameters and the set of time resources reserved for receipt of the at least one transmission (e.g., sidelink data, sidelink feedback). By outputting the information (e.g., parameters, time resources reserved for receipt of a transmission (e.g., sidelink data, sidelink feedback)) between the first RAT modem and the second RAT modem, the communication manager 101 may enabled the UE 115 to refrain from communicating (e.g., transmitting, receiving) using the second RAT modem during the set of time resources, and receive, via the first RAT modem the transmission (e.g., sidelink data, sidelink feedback) using one or more parameters of the set of parameters and one or more resources of the set of time resources. Additionally, by enabling the UE 115 to support exchange of information (e.g., parameters, time resources reserved for receipt of a transmission (e.g., sidelink data, sidelink feedback)) between the first RAT modem and the second RAT modem, the UE 115 may experience reduced or eliminated channel coexistence interference (e.g., in-device coexistence interference) between the first RAT modem and the second RAT modem of the UE 115.

The communication manager 101 may receive, at a first RAT modem of the UE 115, SCI indicative of a set of time resources (e.g., a set of slots) reserved for receipt of a packet from one or more second UEs 115 via the first RAT modem of the UE 115. The communication manager 101 may output, from the first RAT modem of the UE 115 to a second RAT modem of the UE 115, information indicative of the set of time resources reserved for receipt of the packet from the one or more second UEs 115 via the first RAT modem. The communication manager 101 may refrain, at the UE 115, from communicating using the second RAT modem of the UE 115 during the set of time resources based at least in part on the information indicative of the set of time resources. The communication manager 101 may receive, via the first RAT modem, the packet using one or more resources of the set of time resources.

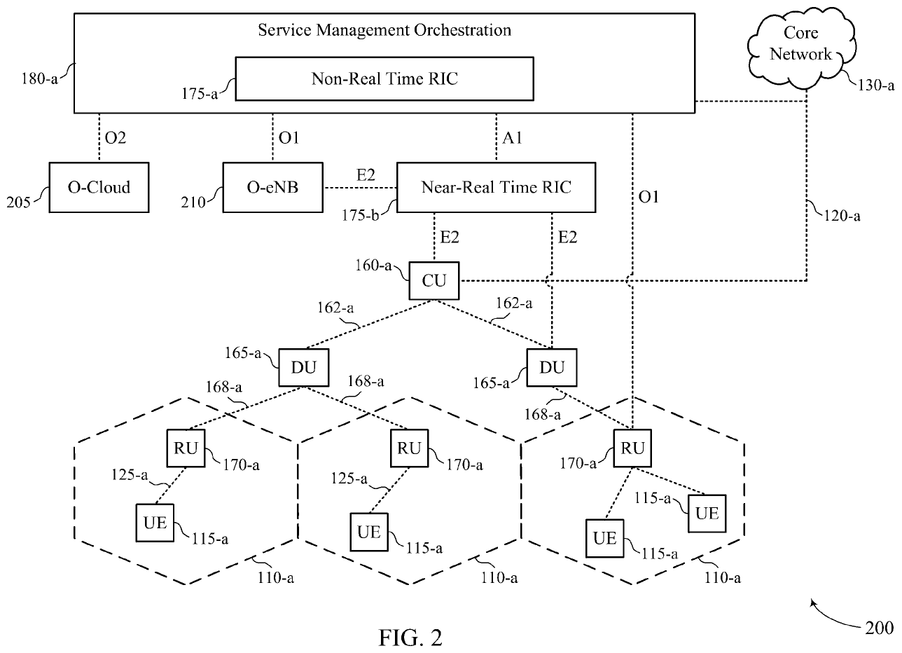

FIG. 2 illustrates an example of a network architecture 200 (e.g., a disaggregated base station architecture, a disaggregated RAN architecture) that supports techniques for managing adjacent channel coexistence for different RATs in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation, and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an Ol interface). Additionally, or alternatively, in some implementations, the SMO 180-a may communicate directly with one or more RUs 170-a via an Ol interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

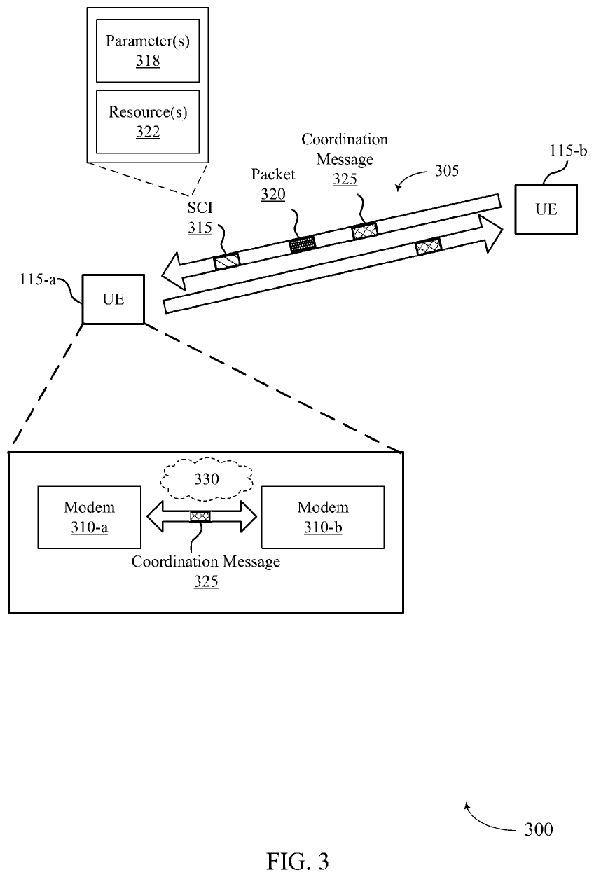

FIG. 3 illustrates an example of a wireless communications system 300 that supports techniques for managing adjacent channel coexistence for different RATs in accordance with one or more aspects of the present disclosure. The wireless communications system 300 may implement or be implemented by aspects of the wireless communications system 100 or the network architecture 200 as described in FIGS. 1 and 2, respectively. For example, the wireless communications system 300 may include a UE 115-a and a UE 115-b, which may be examples of UEs 115 as described with reference to FIG. 1.

The wireless communications system 300 may support multiple RATs including 4G RAT such as LTE, LTE-A, or LTE-A Pro, and 5G RAT which may be referred to as NR systems, including future radio technologies, such as sixth generation (6G), including future advanced C-V2X, and beyond 6G. Additionally, or alternatively, the wireless communications system 300 may Wi-Fi, DSRC, or other 802.11p RATs. The wireless communications system 300 may support power saving, and, in some examples, may promote high reliability and low latency wireless communications by managing adjacent channel coexistence for different RATs.

In the wireless communications system 300, the UE 115-a may perform wireless communication (e.g., sidelink reception, sidelink transmission) with the UE 115-b via a communication link 305, which may be an example of a sidelink communication link or PC5 link. The communication link 305 may include a bidirectional supporting both sidelink transmission and sidelink reception.

In the example of FIG. 3, the UE 115-a may be configured (e.g., equipped) with multiple radios to support wireless communication via multiple RATs. The UE 115-a may be referred to as a dual-radio UE, including multiple RAT modems. For example, the UE 115-a may be configured (e.g., equipped) with a modem 310-a associated with a first RAT and a modem 310-b associated with a second RAT. As an example, the first RAT include LTE-V 2X, NR-V2X, or other RATs beyond 5G. The first RAT may support vehicular applications and use-cases (e.g., safety and emergency signaling). The second RAT may include DSRC, Wi-Fi, or other 802.11p RATs.

The modem 310-a of the UE 115-a may be communicatively coupled to the modem 310-b of the UE 115-a, as will be described in further detail herein. In some cases, each of the modem 310-a and the modem 310-b may be associated with separate RF chains and/or hardware components (e.g., separate RF chains/hardware that are dedicated to the respective modems/RATs). Additionally, or alternatively, the modem 310-a and the modem 310-b may share one or more RF chains and/or hardware components. In other implementations, some RF components may be shared between the modem 310-a and the modem 310-b, while other hardware components may be dedicated (e.g., not shared) for each of the modem 310-a and the modem 310-b.

In the wireless communications system 300, one or more of the UE 115-a and the UE 115-b, or a combination thereof may exchange information (e.g., messages, packets, control information, data) in order to mitigate or reduce in-device interference 330 between RATs. For example, the UE 115-a may receive, at the modem 310-a of the UE 115-a, SCI 315 indicative of a set of parameters 318 and a set of time resources 322 reserved for receipt of a packet 320 from the UE 115-b via a first RAT (e.g., LTE-V2X, NR-V2X, or other RATs beyond 5G) associated with the modem 310-a of the UE 115-a.

The UE 115-a may output, from the modem 310-a of the UE 115-a to the modem 310-b of the UE 115-a, information indicative of the set of parameters 318 and the set of time resources 322 reserved for receipt of the packet 320 from the UE 115-b via the first RAT associated with the modem 310-a. The modem 310-b may be associated with a second RAT (e.g., DSRC, Wi-Fi, or other 802.11p RATs). The UE 115-a may refrain from communicating using the modem 310-b of the UE 115-a during the set of time resources based on the information indicative of the set of parameters 318 and the set of time resources. The UE 115-a may receive, via the first RAT (e.g., LTE-V2X, NR-V2X, or other RATs beyond 5G) and using the modem 310-a, the packet 320 using one or more parameters of the set of parameters 318 and one or more resources of the set of time resources 322. As described herein, refrain may include pausing wireless communication (e.g., uplink transmission, sidelink transmission, sidelink reception) for a duration, terminating wireless communication (e.g., uplink transmission, sidelink transmission, sidelink reception), releasing resources associated with wireless communication, etc.

The UE 115-a including the modem 310-a configured to support the first RAT (e.g., LTE-V2X, NR-V2X, or other RATs beyond 5G) may generate a data structure indicative of the set of time resources reserved for receipt of the packet 320 from the UE 115-b via the first RAT associated with the modem 310-a. The information indicative of the set of time resources include the data structure. For example, the UE 115-a including the modem 310-a configured to support the first RAT (e.g., LTE-V2X, NR-V2X, or other RATs beyond 5G) may form a list of slots reserved for receipt of the packet 320 from the UE 115-b via the first RAT associated with the modem 310-a.

The UE 115-a including the modem 310-a configured to support the first RAT (e.g., LTE-V2X, NR-V2X, or other RATs beyond 5G) may determine the set of time resources (e.g., slots) reserved for receipt of the packet 320 from the UE 115-b via the first RAT associated with the modem 310-a based on the SCI 315. In some examples, the SCI 315 may be a first stage SCI (e.g., SCI-1). For example, the UE 115-a may receive an SCI-1 over a physical sidelink control channel (PSCCH), which the UE 115-a may decode to determine the set of time resources (e.g., slots) reserved for receipt of the packet 320 from the UE 115-b via the first RAT associated with the modem 310-a. In some examples, the UE 115-a may identify reservation information based on the decoded SCI-1, and the UE 115-a including the modem 310-a configured to support the first RAT (e.g., LTE-V2X, NR-V2X, or other RATs beyond 5G) may determine the set of time resources (e.g., slots) reserved for receipt of the packet 320 from the UE 115-b via the first RAT associated with the modem 310-a based on the reservation information.

In some other examples, the SCI 315 may be a second stage SCI (e.g., SCI-2). For example, the UE 115-a may receive an SCI-2 over a physical sidelink shared channel (PSSCH), which the UE 115-a may decode to determine the set of time resources (e.g., slots) reserved for receipt of the packet 320 from the UE 115-b via the first RAT associated with the modem 310-a. In some examples, the UE 115-a may identify a layer one (L1) identifier based on the decoded SCI-2. The L1 identifier may be a source L1 identifier or a destination L1 identifier. As such, the source L1 identifier may be associated with (e.g., identify) the UE 115-b and the destination L1 identifier may be associated with (e.g., identify) the UE 115-a. The UE 115-a including the modem 310-a configured to support the first RAT (e.g., LTE-V2X, NR-V2X, or other RATs beyond 5G) may determine to receive the packet 320 from the UE 115-b via the first RAT associated with the modem 310-a based on the L1 identifier. That is, the UE 115-a may receive the packet 320 based on a determination that the packet 320 is intended for the UE 115-a based on the L1 identifier. Additionally, or alternatively, the UE 115-a may receive the packet 320 based on a determination that the packet 320 is intended for the UE 115-a based on the L1 identifier and a communication range associated with the first RAT (e.g., LTE-V2X, NR-V2X, or other RATs beyond 5G) and/or the second RAT (e.g., DSRC, Wi-Fi, or other 802.11p RATs).

The UE 115-a including the modem 310-a configured to support the first RAT (e.g., LTE-V2X, NR-V2X, or other RATs beyond 5G) or the modem 310-b configured to support the second RAT (e.g., DSRC, Wi-Fi, or other 802.11p RATs) may determine a set of time resource (e.g., slots), which may be associated with retransmission of wireless communication to or from the modem 310-a associated with the first RAT (e.g., LTE-V2X, NR-V2X, or other RATs beyond 5G). In some examples, the UE 115-a including the modem 310-a configured to support the first RAT (e.g., LTE-V2X, NR-V2X, or other RATs beyond 5G) may based on decoding the SCI 315 (e.g., SCI-1 and/or SCI-2) determine the set of time resource (e.g., slots) for initial transmission and/or retransmission of the packet 320. These set of time resource (e.g., slots) for an initial transmission and/or a retransmission of the packet 320 may be included in the list of slots reserved for receipt of the packet 320 from the UE 115-b via the first RAT associated with the modem 310-a.

For example, if initial reception of the packet 320 from the UE 115-b via the first RAT associated with the modem 310-a is estimated to be successful (e.g., a measured RSRP of an initial transmission of the packet 320 is higher than a threshold), then one or more resources of the set of time resources reserved for retransmission is not avoided by the modem 310-b of the UE 115-a configured to support the second RAT (e.g., DSRC, Wi-Fi, or other 802.11p RATs). Additionally, or alternatively, a hybrid automatic repeat request (HARQ) identifier may be included in the of slots reserved for receipt of the packet 320 from the UE 115-b via the first RAT associated with the modem 310-a. In some examples, the modem 310-b of the UE 115-a configured to support the second RAT (e.g., DSRC, Wi-Fi, or other 802.11p RATs) may determine whether to avoid one or more resources of the set of time resources reserved for retransmission. For example, the modem 310-b of the UE 115-a configured to support the second RAT (e.g., DSRC, Wi-Fi, or other 802.11p RATs) may avoid a first and/or a second retransmission of the packet 320, and not ignore a third and/or a fourth retransmission of the packet 320.

The UE 115-a including the modem 310-b configured to support the second RAT (e.g., DSRC, Wi-Fi, or other 802.11p RATs) may refrain from communicating on a set of time resources based on an overlap between a first time resource (e.g., a first slot, a first duration) reserved for the first RAT associated with the modem 310-a and a second time resource (e.g., a second slot, a second duration) reserved for the second RAT associated with the modem 310-b. The UE 115-a including the modem 310-b configured to support the second RAT (e.g., DSRC, Wi-Fi, or other 802.11p RATs) may delay a channel access operation (e.g., CCA). For example, CCA may be cancelled and reset after NR-V2X reception. Alternatively, the UE 115-a including the modem 310-b configured to support the second RAT (e.g., DSRC, Wi-Fi, or other 802.11p RATs) may pause (e.g., freeze) a channel access operation (e.g., CCA). For example, a CCA counter may be frozen (e.g., paused) during NR-V2X reception and resumed after the NR-V2X reception.

Returning to the UE 115-a including the modem 310-a configured to support the first RAT (e.g., LTE-V2X, NR-V2X, or other RATs beyond 5G) forming the list of slots reserved for receipt of the packet 320 from the UE 115-b via the first RAT associated with the modem 310-a, in some examples, the list of slots may be based on a priority associated with the packet 320. The UE 115-a including the modem 310-a configured to support the first RAT (e.g., LTE-V2X, NR-V2X, or other RATs beyond 5G) may determine the priority of the packet 320 based on the received SCI 315, which may indicate the priority of the packet 320. The UE 115-a including the modem 310-a configured to support the first RAT (e.g., LTE-V2X, NR-V2X, or other RATs beyond 5G) may determine the set of time resources reserved for receipt of the packet 320 from the UE 115-b via the first RAT associated with the modem 310-a based on the priority associated with the packet 320.

The set of time resources may be based on the priority associated with the packet 320 satisfying a threshold. For example, the priority of the packet 320 may be higher compared to other packets because the packet 320 may carry information related to traffic conditions, signal scheduling, weather, safety, emergencies, or any other information relevant to, for example, a V2X system. In some examples, to avoid transmission latency for wireless communication (e.g., transmission, reception) associated with the second RAT (e.g., DSRC, Wi-Fi, or other 802.11p RATs) at the modem 310-b of the UE 115-a from increasing, the UE 115-a exclusively include packets that satisfy the threshold (e.g., ThNR-V2X, pkt). The list may also include PPPP of the packet 320, so the UE 115-a including the modem 310-b configured to support the second RAT (e.g., DSRC, Wi-Fi, or other 802.11p RATs) may determine one or more slots in the list to avoid (e.g., avoid high priority NR-V2X packets).

The list of slots, in some other examples, may be based on a measurement value associated with the packet 320. For example, the UE 115-a including the modem 310-a configured to support the first RAT (e.g., LTE-V2X, NR-V2X, or other RATs beyond 5G) may measure an RSRP associated with the packet 320. The UE 115-a including the modem 310-a configured to support the first RAT (e.g., LTE-V2X, NR-V2X, or other RATs beyond 5G) may determine the set of time resources reserved for receipt of the packet 320 from the UE 115-b via the first RAT associated with the modem 310-a based on the measured RSRP associated with the packet 320.

A high measured RSRP may be indicative of a good link status associated with the communication link 305 between the UE 115-a and the UE 115-b. In contrast, a low measured RSRP may be indicative of a poor link status associated with the communication link 305 between the UE 115-a and the UE 115-b As such, a good link status may correspond to a higher likelihood of a successful decoding of the packet 320 compared to a poor link status, which may have a lower likelihood of a successful decoding of the packet 320 compared to the good link status. In some example, if the UE 115-a determines that reception of the packet 320 via the first RAT (e.g., LTE-V2X, NR-V2X, or other RATs beyond 5G) and using the modem 310-a of the UE 115-a may occur because of a low measured RSRP associated with the packet 320, the UE 115-a including the modem 310-b configured to support the second RAT (e.g., DSRC, Wi-Fi, or other 802.11p RATs) may refrain from delay or pausing (e.g., freezing) a channel access operation (e.g., LBT, CCA). In some examples, the modem 310-a of the UE 115-a may output a command to the modem 310-b of the UE 115-a to delay or pause the channel access operation (e.g., LBT, CCA) or a channel access counter (e.g., CCA counter freeze ON/OFF command).

The UE 115-a including the modem 310-a configured to support the first RAT (e.g., LTE-V2X, NR-V2X, or other RATs beyond 5G) may inform the modem 310-b configured to support the second RAT (e.g., DSRC, Wi-Fi, or other 802.11p RATs) of a set of time resources (e.g., slots) or a period (e.g., a duration) for a pending physical sidelink feedback channel (PSFCH) reception at the modem 310-b of the UE 115-a. Put another way, the modem 310-a may inform the modem 310-b where it expects to receive a PSFCH transmission. In some examples, the UE 115-a including the modem 310-a configured to support the first RAT (e.g., LTE-V2X, NR-V2X, or other RATs beyond 5G) may determine to receive PSFCH after each of one or more PSSCH reception at the modem 310-a of the UE 115-a. Additionally, the UE 115-a including the modem 310-a may inform the modem 310-b of the UE 115-a a feedback mode, which may be a configured grant modem (e.g., configured grant mode 1 feedback-based retransmission). That is, the UE 115-b including the modem 310-a may exclusively transmit feedback, which may be a negative acknowledgment, for each of one or more PSSCH reception at the modem 310-a of the UE 115-a based on the feedback mode. A reception occurrence with a low RSRP may be expected of a NAK feedback.

In some examples, the UE 115-a including the modem 310-a configured to support the first RAT (e.g., LTE-V2X, NR-V2X, or other RATs beyond 5G) may inform the modem 310-b configured to support the second RAT (e.g., DSRC, Wi-Fi, or other 802.11p RATs) of a set of time resources (e.g., slots) or a period (e.g., a duration) where other UEs (e.g., the UE 115-b) are expecting a PSFCH reception. For example, the UE 115-a may receive an SCI (e.g., SCI-1 and/or SCI-2) from other UEs, such as the SCI 315 from the UE 115-b, and determine based on the received CSI that the other UEs are expecting PSFCH reception. In some examples, the UE 115-a including the modem 310-a configured to support the first RAT (e.g., LTE-V2X, NR-V2X, or other RATs beyond 5G) may detect the other UEs (e.g., the UE 115-b) based on RSRP measurements or based on zone information associated with the other UEs (e.g., the UE 115-b), including zone identifiers associated with each of the other UEs (e.g., the UE 115-b). The UE 115-a including the modem 310-b may avoid communicating on the set of time resources (e.g., slots) or the period (e.g., a duration) where other UEs (e.g., the UE 115-b) are expecting the PSFCH reception. For example, the UE 115-a including the modem 310-b may delay a channel access operation (e.g., CCA) or pause the channel access operation (e.g., CCA).

In the example of FIG. 3, the UE 115-a may inform the UE 115-b of information indicative of the set of time resources (e.g., slots) reserved by the UE 115-a. The set of time resources may be a set of non-preferred resources. The UE 115-a may inform the UE 115-b of information indicative of the set of time resources (e.g., slots) reserved by the UE 115-a via inter-UE coordination messaging. For example, the UE 115-a may output, from the modem 310-a of the UE 115-a to the modem 310-b of the UE 115-a, a coordination message 325, which may indicate the set of time resources reserved for receipt of the packet 320 from the UE 115-b via the modem 310-a. The coordination message 325 may be referred to as an inter-UE coordination message. In some examples, the UE 115-a may inform other UEs 115 (e.g., the UE 115-b) of the set of time resources (e.g., one or more slots) reserved for receipt of the packet 320 from the UE 115-b at the modem 310-a of the UE 115-a.

In some other examples, the UE 115-a may receive, at the modem 310-a of the UE 115-a, the coordination message 325 from other UEs 115 (e.g., the UE 115-b) and forward the coordination message 325 from the modem 310-a to the modem 310-b of the UE 115-a. In some examples, one or more RSRP measurements associated with the coordination message 325 (e.g., inter-UE coordination messages) may be used as a condition for indicating, to the modem 310-b of the UE 115, the set of time resources (e.g., one or more slots) reserved for receipt of the packet 320 at the modem 310-a of the UE 115-a. For example, the modem 310-b of the UE 115 may indicate, to the modem 310-b of the UE 115, the set of time resources (e.g., one or more slots) reserved based on the one or more RSRP measurements associated with the coordination message 325 (e.g., inter-UE coordination messages) satisfying a threshold (e.g., measured RSRP is larger than a threshold).

The set of time resources (e.g., one or more slots) may be determined based on the UE 115-a including the modem 310-a detecting SCI-1 from other UEs 115 (e.g., the UE 115-b). Alternatively, the set of time resources (e.g., one or more slots) may be determined based on the UE 115-a including the modem 310-a detecting SCI-2 or a medium access control-control element (MAC-CE) of the coordination message 325. The modem 310-b of the UE 115 may then avoid the set of time resources (e.g., one or more slots) reserved for the modem 310-a of the UE 115-a or for other UEs 115. As such, the coordination message 325 may indicate resources usable for communications on the respective RATs so that the modem 310-a and/or the modem 310-b may select (e.g., re-select) resources that will avoid in-device interference 330 (e.g., DSRC and NR-V2X coordination on SPS resource reservation).

By enabling the UE 115-a to support exchange of information (e.g., parameters, time resources reserved for receipt of a transmission (e.g., sidelink data, sidelink feedback)) between the modem 310-a and the modem 310-b, the UE 115-a may experience reduced or eliminated in-device interference 330 (e.g., channel coexistence interference) between the modem 310-a and the modem 310-b of the UE 115-a.

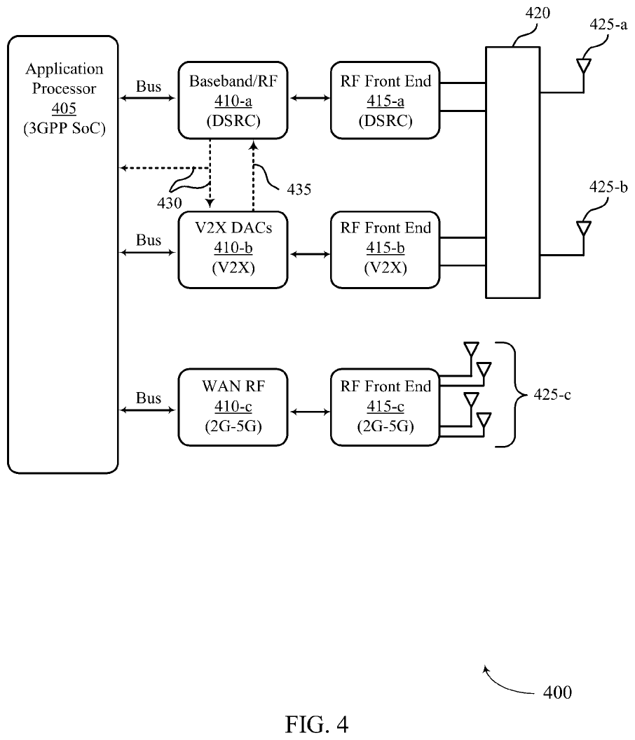

FIG. 4 illustrates an example of an RFFE radio module 400 that supports techniques for managing adjacent channel coexistence for different RATs in accordance with one or more aspects of the present disclosure. Aspects of the RFFE radio module 400 may implement, or be implemented by, aspects of wireless communications system 100, the network architecture 200, the wireless communications system 300, or any combination thereof. In particular, the RFFE radio module may illustrate how RF components may be shared across multiple RATs and/or modems, such as a modem supporting LTE-V2X, NR-V2X, or other RATs beyond 5G and a modem supporting DSRC, Wi-Fi, or other 802.11p RATs.

The RFFE radio module 400 may be implemented at a UE 115 for DSRC/V2X coexistence. As shown in FIG. 4, the RFFE radio module 400 may include an application processor 405, which may include an example of a system-on-a-chip (SoC) (e.g., 3rd Generation Partnership Project (3GPP) SOC) at the UE 115. The application processor 405 may be communicatively coupled (via one or more busses, such as a universal serial bus (USB), a peripheral component interconnect express (PCIe), a secure digital input output (SDIO)) to a baseband component 410-a for wireless communication associated with DSRC, Wi-Fi, or other 802.11p RATs, a V2X digital-to-analog converter (DAC) component 410-b for wireless communication associated with LTE-V2X, NR-V2X, or other RATs beyond 5G, and a wireless area network (WAN) RF component 410-c for cellular communications (e.g., Second Generation (2G), Third Generation (3G), 4G, 5G, and RATs beyond 5G).

The baseband component 410-a may include a SoC baseband and RF components for DSRC communications (e.g., 802.11p communications). The baseband component 410-a may be communicatively coupled to an RF front end 415-a associated with wireless communication associated with DSRC, Wi-Fi, or other 802.11p RATs (e.g., intelligent transport system (ITS)-G5). The RF front end 415-a may include power amplifiers, low noise amplifiers (LNAs), and the like. Similarly, the V2X DAC component 410-b (e.g., I/Q analog-to-digital (A2D) DACs) may be communicatively coupled to an RF front end 415-b for V2X communications, and the WAN RF component 410-c may be communicatively coupled to an RF front end 415-b for cellular communications (e.g., 2G, 3G, 4G, 5G, and RATs beyond 5G).

The RF front ends 415-a, 415-b for the DSRC and V2X communications may communicatively coupled with a Tx/Rx switching network 420 that includes various amplifiers, switches, splitters, LNAs, and the like. The Tx/Rx switching network 420 may couple the RF front ends 415 with a first antenna module 425-a associated with DSRC communications, and a second antenna module 425-b that is shared for both DSRC and V2X communications. Similarly, the RF front end 425-c may be coupled with a third antenna module 415-c for cellular communications (e.g., 2G, 3G, 4G, 5G, and RATs beyond 5G).

In some implementations, the baseband component 410-a associated with DSRC communications may communicate signals 430 to a baseband component associated with V2X communications (e.g., NR-V2X baseband). Conversely, the V2X DAC component 410-b may communicate signals 435 (e.g., co-ex manager signals/interrupts) to the baseband component 410-a. As described herein, the signals 430 and/or 435 may be used to reduce or eliminate in-device coexistence interference across the respective RATs.

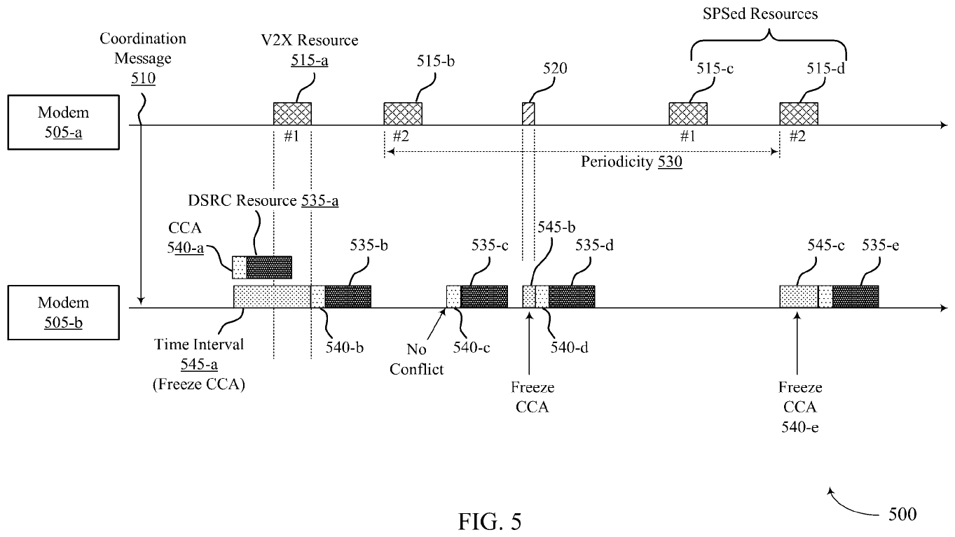

FIG. 5 illustrates an example of a resource configuration 500 that supports techniques for managing adjacent channel coexistence for different RATs in accordance with one or more aspects of the present disclosure. Aspects of the resource configuration 500 may implement, or be implemented by, aspects of the wireless communications system 100, the network architecture 200, the wireless communications system 300, the RFFE radio module 400, or any combination thereof.

The resource configuration 500 illustrates communications performed by a modem 505-a associated with a first RAT (e.g., LTE-V2X, NR-V2X, or other RATs beyond 5G) and a second modem 505-b associated with a second RAT (e.g., DSRC, Wi-Fi, or other 802.11p RATs). In this regard, the modem 505-a and the second modem 505-b illustrated in FIG. 5 may include examples of the modem 310-a and the modem 310-b, respectively, as illustrated in FIG. 3.

In some cases, the modem 505-a may communicate, to the modem 505-b, a coordination message 510 indicating information associated with resources used for communications via the first RAT (e.g., LTE-V2X, NR-V2X, or other RATs beyond 5G). For example, described previously herein, the coordination message 510 may indicate time and frequency domain information associated with V2X resources 515 used by the modem 505-a for V2X messages. In some cases, the coordination message 510 may additionally indicate one or more periodicities 530 associated with the V2X resources 515 (e.g., reservation periodicity Pᵣₛᵥₚ), an SPS counter associated with the set of V2X resources 515, feedback resource 520 associated with the V2X resources 515, or any combination thereof.

The modem 505-b may be configured to utilize information communicated via the coordination message 510 to avoid conflicts between V2X messages communicated via the V2X resources 515 and DSRC messages communicated via DSCR resources 535. In particular, in some examples, the modem 505-b may be configured to freeze a CCA operation 540 if the modem 505-a is transmitting (or is about to transmit) a V2X packet via a V2X resource. In particular, the modem 505-b (e.g., DSRC modem) may be configured to avoid transmitting DSRC packets that would collide with V2X packets transmitted within V2X resources 515, where the V2X resources 515 may be defined by [v2xStart+j*P, v2xEnd+j*P], j∈[0, SPS_{counter}]. Further, the modem 505-b may be configured to avoid transmitting DSRC packets that would interfere with feedback resources 520 for V2X messages (e.g., two feedback symbols). A DSRC modem may avoid NR-V2X feedback reception PSFCH (2 symbols) after PSSCH transmission.

For example, as shown in FIG. 5, the modem 505-b may freeze a CCA operation 540-a for a DSRC resource 535-a during a time interval 545-a based on a DSRC packet within DSRC resource 535-a being expected to overlap with (e.g., collide with) a V2X packet within the V2X resource 515-a. In this regard, the modem 505-b may freeze the CCA operation 540-a during time interval 545-a, and may refrain from transmitting a packet within the DSRC resource 535-a. Following an end of the time interval 545-a (and after an end of the V2X resource 515-b), the modem 505-b may resume (or restart) a CCA operation 540-b, and may transmit a packet within the DSRC resource 535-b (after successful completion of the CCA operation 540-b).

As shown in FIG. 5, the modem 505-b may determine (based on the coordination message 510) that there is no conflict between the DSRC resource 535-c and the V2X resources 515, and may therefore perform a CCA operation 540-c and transmit a packet within the DSRC resource 535-c (after successful completion of the CCA operation 540-c).

Comparatively, the modem 505-b may identify a feedback resource 520 associated with the V2X resources 515 based on the coordination message 510. As such, the modem 505-b may freeze a CCA operation 540-d during a time interval 545-b that overlaps with the feedback resource 520. In other words, the modem 505-b may freeze the CCA operation 540-d when a collision is expected with V2X feedback symbols. In this example, following an end of the time interval 545-b (e.g., after an end of the feedback resource 520), the modem 505-b may resume (or restart) the CCA operation 540-d, and may transmit a packet within the DSRC resource 535-d (after successful completion of the CCA operation 540-d).

Similarly, the modem 505-b may identify SPS V2X resources 515-c and 515-d based on the coordination message 510, and may freeze a CCA operation 540-e during a time interval 545-c that overlaps with the V2X resource 515-d. In this example, following an end of the time interval 545-c (e.g., after an end of the V2X resource 515-d), the modem 505-b may resume (or restart) the CCA operation 540-e, and may transmit a packet within the DSRC resource 535-e (after successful completion of the CCA operation 540-e).

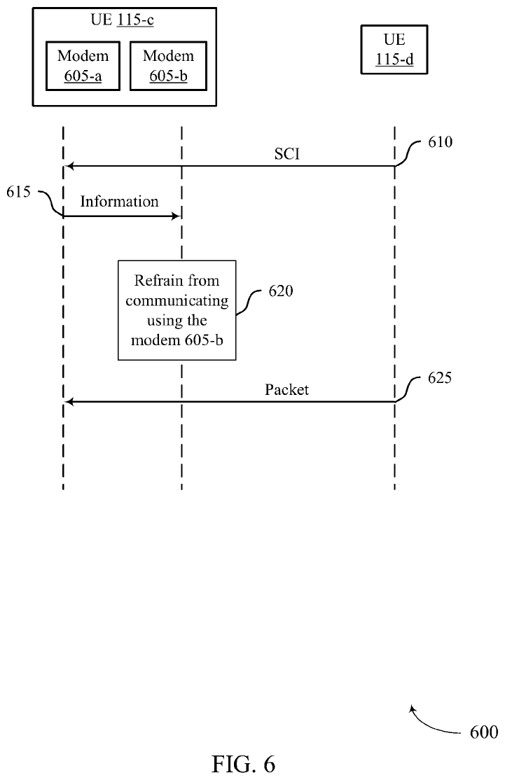

FIG. 6 illustrates an example of a process flow 600 that supports techniques for managing adjacent channel coexistence for different RATs in accordance with one or more aspects of the present disclosure. In some examples, the process flow 600 may implement or be implemented by aspects of the wireless communications system 100, the network architecture 200, the wireless communications system 300, the RFFE radio module 400, the resource configuration 500, or any combination thereof as described with reference to FIGS. 1 through 5, respectively. For example, the process flow 600 may be implemented by a UE 115-c and a UE 115-d, which may be an example of UEs 115 as described with reference to FIGS. 1 through 3, respectively. In the following description of the process flow 600, the operations between the UE 115-c and the UE 115-d may be transmitted in a different order than the example order shown, or the operations performed by the UE 115-c and the UE 115-d may be performed in different orders or at different times. Some operations may also be omitted from the process flow 600, and other operations may be added to the process flow 600.

The UE 115-c may be configured to support wireless communication via a modem 605-a configured to support LTE-V2X, NR-V2X, or other RATs beyond 5G and a modem 605-b configured to support DSRC, Wi-Fi, or other 802.11p RATs. In the example of FIG. 6,, at 610, the UE 115-c may receive, at the modem 605-a of the UE 115-c, SCI indicative of a set of parameters and a set of time resources (e.g., one or more slots) reserved for receipt of at least one transmission (e.g., sidelink data, sidelink feedback) from the UE 115-d via the modem 605-a. The set of parameter may include a priority associated with the at least one transmission, a physical layer configuration associated with one or both of the modem 605-a of the UE 115-c or the modem 605-b of the UE 115-c, or a RSRP associated with the transmission, among other examples as described herein.

At 615, the UE 115-c may output, from the modem 605-a to the modem 605-b, information indicative of the set of parameters and the set of time resources reserved for receipt of the at least one transmission (e.g., sidelink data, sidelink feedback). By outputting the information (e.g., parameters, time resources reserved for receipt of a transmission (e.g., sidelink data, sidelink feedback)) between the modem 605-a and the modem 605-b, the UE 115-c may refrain, at 620, from communicating (e.g., transmitting, receiving) using the modem 605-b during the set of time resources, and receive, at 625, via the modem 605-a the transmission (e.g., sidelink data, sidelink feedback) using one or more parameters of the set of parameters and one or more resources of the set of time resources. Additionally, by enabling the UE 115-c to support exchange of information (e.g., parameters, time resources reserved for receipt of a transmission (e.g., sidelink data, sidelink feedback)) between the modem 605-a and the modem 605-b, the UE 115-c may experience reduced or eliminated channel coexistence interference (e.g., in-device coexistence interference) between the modem 605-a and the modem 605-b of the UE 115-c.

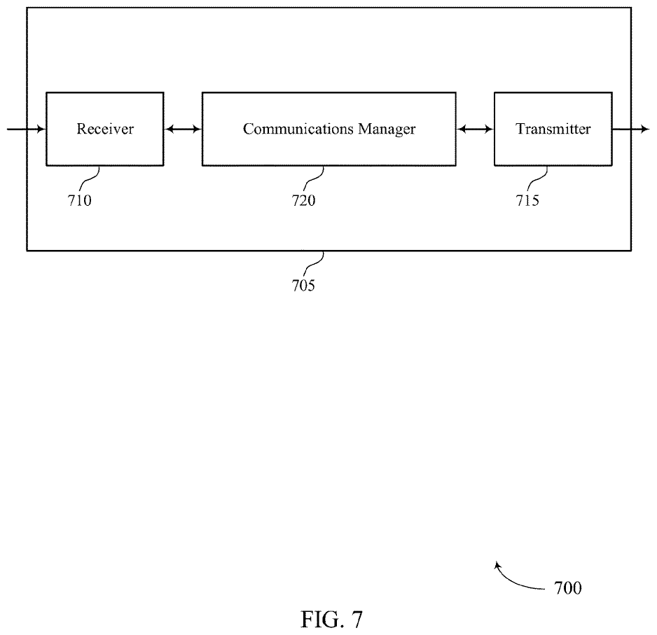

FIG. 7 illustrates a block diagram 700 of a device 705 that supports techniques for managing adjacent channel coexistence for different RATs in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for managing adjacent channel coexistence for different RATs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for managing adjacent channel coexistence for different RATs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for managing adjacent channel coexistence for different RATs as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE (e.g., the device 705) in accordance with examples as disclosed herein. For example, the communications manager 720 may be configured as or otherwise support a means for receiving, at a first RAT modem of the first UE, SCI indicative of a set of parameters and a set of time resources reserved for receipt of at least one packet from one or more second UEs via a first RAT associated with the first RAT modem of the first UE. The communications manager 720 may be configured as or otherwise support a means for outputting, from the first RAT modem of the first UE to a second RAT modem of the first UE, information indicative of the set of parameters and the set of time resources re-serving for receipt of the at least one packet from the one or more second UEs via the first RAT associated with the first RAT modem, the second RAT modem being associated with a second RAT different from the first RAT. The communications manager 720 may be configured as or otherwise support a means for refraining, at the first UE, from communicating using the second RAT modem of the first UE during the set of time resources based on the information indicative of the set of parameters and the set of time resources. The communications manager 720 may be configured as or otherwise support a means for receiving, via the first RAT and using the first RAT modem, the at least one packet using one or more parameters of the set of parameters and one or more resources of the set of time resources.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced power consumption.

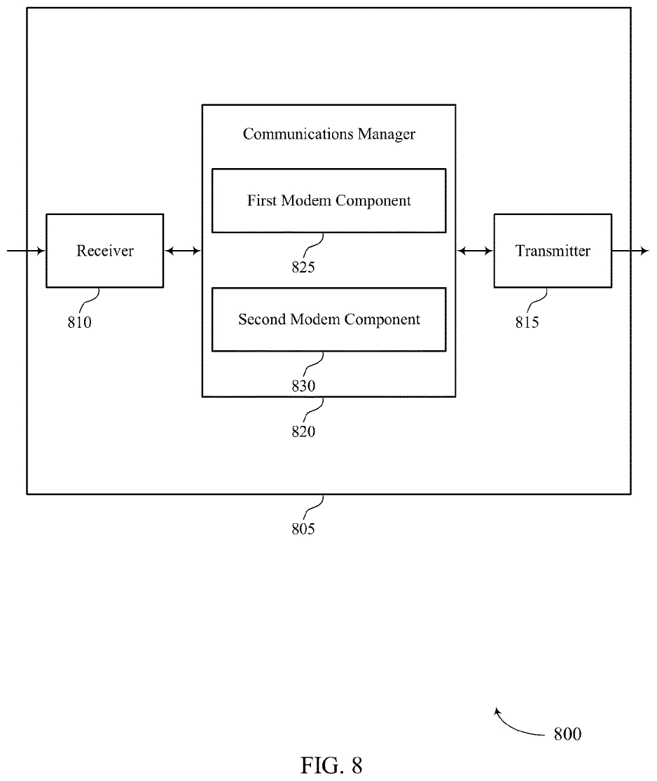

FIG. 8 illustrates a block diagram 800 of a device 805 that supports techniques for managing adjacent channel coexistence for different RATs in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for managing adjacent channel coexistence for different RATs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for managing adjacent channel coexistence for different RATs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for managing adjacent channel coexistence for different RATs as described herein. For example, the communications manager 820 may include a first modem component 825 a second modem component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE (e.g., the device 805) in accordance with examples as disclosed herein. The first modem component 825 may be configured as or otherwise support a means for receiving, at a first RAT modem of the first UE, SCI indicative of a set of parameters and a set of time resources reserved for receipt of at least one packet from one or more second UEs via a first RAT associated with the first RAT modem of the first UE. The first modem component 825 may be configured as or otherwise support a means for outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT. The second modem component 830 may be configured as or otherwise support a means for refraining, at the first UE, from communicating using the second RAT modem of the first UE during the set of time resources based on the information indicative of the set of parameters and the set of time resources. The first modem component 825 may be configured as or otherwise support a means for receiving, via the first RAT and using the first RAT modem, the at least one packet using one or more parameters of the set of parameters and one or more resources of the set of time resources.

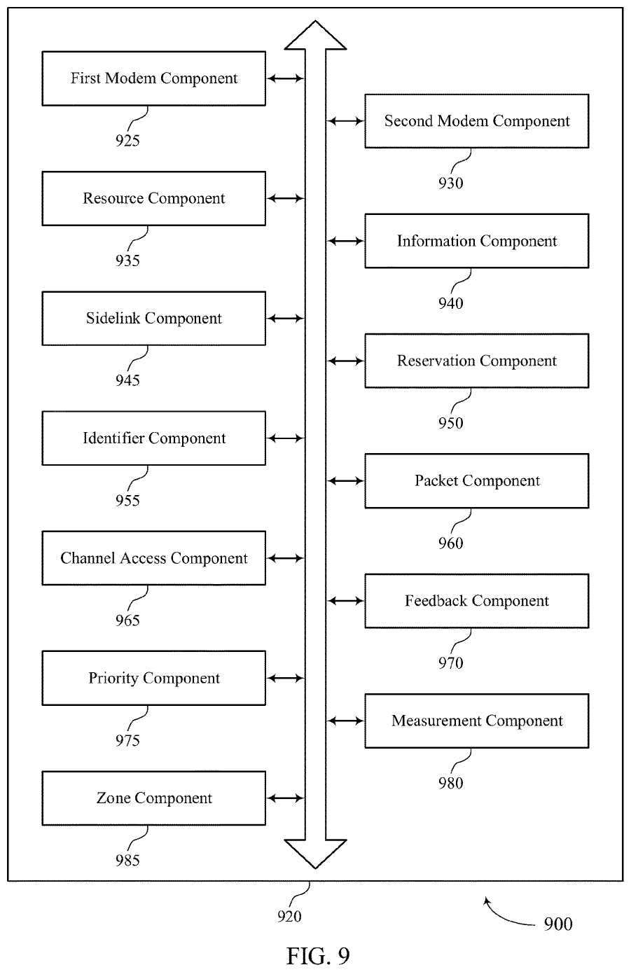

FIG. 9 illustrates a block diagram 900 of a communications manager 920 that supports techniques for managing adjacent channel coexistence for different RATs in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for managing adjacent channel coexistence for different RATs as described herein. For example, the communications manager 920 may include a first modem component 925, a second modem component 930, a resource component 935, an information component 940, a sidelink component 945, a reservation component 950, an identifier component 955, a packet component 960, a channel access component 965, a feedback component 970, a priority component 975, a measurement component 980, a zone component 985, or any combination thereof. Each of these components may communicate, directly or indirectly, with one another (e.g., via one or more buses).

The communications manager 920 may support wireless communication at a first UE in accordance with examples as disclosed herein. The first modem component 925 may be configured as or otherwise support a means for receiving, at a first RAT modem of the first UE, SCI indicative of a set of parameters and a set of time resources reserved for receipt of at least one packet from one or more second UEs via a first RAT associated with the first RAT modem of the first UE. In some examples, the first modem component 925 may be configured as or otherwise support a means for outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT. The second modem component 930 may be configured as or otherwise support a means for refraining, at the first UE, from communicating using the second RAT modem of the first UE during the set of time resources based on the information indicative of the set of parameters and the set of time resources. In some examples, the first modem component 925 may be configured as or otherwise support a means for receiving, via the first RAT and using the first RAT modem, the at least one packet using one or more parameters of the set of parameters and one or more resources of the set of time resources.

In some examples, refraining from communicating using the second RAT modem of the first UE during the set of time resources is based on an overlap between a first time resource reserved for the first RAT associated with the first RAT modem and a second time resource reserved for the second RAT associated with the second RAT modem.

In some examples, the resource component 935 may be configured as or otherwise support a means for determining the set of time resources reserved for receipt of the at least one packet from the one or more second UEs via the first RAT associated with the first RAT modem based on the SCI.

In some examples, the information component 940 may be configured as or otherwise support a means for generating a data structure indicative of the set of time resources reserved for receipt of the at least one packet from the one or more second UEs via the first RAT associated with the first RAT modem, where the information indicative of the set of time resources includes the data structure.

In some examples, the SCI includes first SCI or second SCI. In some examples, outputting the information indicative of the set of time resources reserved for receipt of the at least one packet from the one or more second UEs via the first RAT associated with the first RAT modem is based on one of the first SCI or the second SCI.

In some examples, to support receiving the SCI, the sidelink component 945 may be configured as or otherwise support a means for receiving first SCI over a PSCCH, the method further including. In some examples, to support receiving the SCI, the reservation component 950 may be configured as or otherwise support a means for identifying reservation information based on the first SCI. In some examples, to support receiving the SCI, the resource component 935 may be configured as or otherwise support a means for determining the set of time resources reserved for receipt of the at least one packet from the one or more second UEs via the first RAT associated with the first RAT modem based on the reservation information.

In some examples, the sidelink component 945 may be configured as or otherwise support a means for receiving second SCI over a PSSCH. In some examples, the identifier component 955 may be configured as or otherwise support a means for identifying a L1 identifier based on the second SCI, where the L1 identifier includes a source L1 identifier or a destination L1 identifier. In some examples, the packet component 960 may be configured as or otherwise support a means for determining to receive the at least one packet from the one or more second UEs via the first RAT associated with the first RAT modem based on the L1 identifier.

In some examples, the resource component 935 may be configured as or otherwise support a means for determining a period indicative of a physical sidelink feedback channel reception at the one or more second UEs or one or more third UEs. In some examples, the first modem component 925 may be configured as or otherwise support a means for outputting, from the first RAT modem of the first UE to the second RAT modem of the first UE, second information indicative of the period indicative of the physical sidelink feedback channel reception at the one or more second UEs or the one or more third UEs. In some examples, the channel access component 965 may be configured as or otherwise support a means for managing a channel access assessment based on the second information, where managing the channel access assessment includes terminating or pausing the channel access assessment.

In some examples, the zone component 985 may be configured as or otherwise support a means for identifying the one or more second UEs or the one or more third UEs based on zone information indicating one or more zones associated with the one or more second UEs or the one or more third UEs.

In some examples, the feedback component 970 may be configured as or otherwise support a means for determining a pending physical sidelink feedback channel reception at the first UE based on one of first SCI or second SCI. In some examples, the channel access component 965 may be configured as or otherwise support a means for managing a channel access assessment based on the pending physical sidelink feedback channel reception, where managing the channel access assessment includes terminating or pausing the channel access assessment.

In some examples, the priority component 975 may be configured as or otherwise support a means for determining a priority associated with the at least one packet. In some examples, the resource component 935 may be configured as or otherwise support a means for determining the set of time resources reserved for receipt of the at least one packet from the one or more second UEs via the first RAT associated with the first RAT modem based on the priority associated with the at least one packet, and where the set of time resources is based on the priority associated with the at least one packet satisfying a threshold.

In some examples, the SCI includes first SCI indicating the priority associated with the at least one packet.

In some examples, the measurement component 980 may be configured as or otherwise support a means for measuring a reference signal received power value associated with the at least one packet. In some examples, the resource component 935 may be configured as or otherwise support a means for determining the set of time resources reserved for receipt of the at least one packet from the one or more second UEs via the first RAT associated with the first RAT modem based on the reference signal received power value associated with the at least one packet.

In some examples, the feedback component 970 may be configured as or otherwise support a means for transmitting feedback associated with the at least one packet based on a decoding result associated with the at least one packet. In some examples, the resource component 935 may be configured as or otherwise support a means for determining a second set of time resources reserved for receipt of the at least one packet from the one or more second UEs via the first RAT associated with the first RAT modem based on the decoding result associated with the at least one packet.

In some examples, the information includes a command for the second RAT modem of the first UE to pause performing a channel access assessment for a duration of time based on a priority associated with the at least one packet.

In some examples, the information includes a command for the second RAT modem of the first UE to terminate a channel access assessment based on a priority associated with the at least one packet.

In some examples, the information indicative of the set of time resources reserved for receipt of the at least one packet from the one or more second UEs via the first RAT associated with the first RAT modem is further indicative of one or more time resources reserved for receipt of a sidelink feedback message over a physical sidelink feedback channel via the first RAT associated with the first RAT modem.

In some examples, the information indicative of the set of time resources reserved for receipt of the at least one packet from the one or more second UEs via the first RAT associated with the first RAT modem is further indicative of a feedback mode associated with the first UE.

In some examples, the information component 940 may be configured as or otherwise support a means for receiving an inter-UE coordination message including second information indicative of a second set of time resources reserved by at least one second UE of the one or more second UEs. In some examples, the first modem component 925 may be configured as or otherwise support a means for outputting, from the first RAT modem of the first UE to the second RAT modem of the first UE, third information indicative of the second set of time resources reserved by the at least one second UE of the one or more second UEs. In some examples, the channel access component 965 may be configured as or otherwise support a means for managing a channel access assessment based on the third information, where managing the channel access assessment includes terminating or pausing the channel access assessment.

In some examples, the measurement component 980 may be configured as or otherwise support a means for measuring a reference signal received power value associated with the inter-UE coordination message. In some examples, the first modem component 925 may be configured as or otherwise support a means for outputting, from the first RAT modem of the first UE to the second RAT modem of the first UE, the third information indicative of the second set of time resources reserved by the at least one second UE of the one or more second UEs based on the reference signal received power value associated with the inter-UE coordination message satisfying a threshold.

In some examples, the set of time resources includes one or more slots.

In some examples, the set of parameters includes one or more of a priority associated with the at least one packet, a physical layer configuration associated with one or both of the first RAT modem of the first UE or the second RAT modem of the first UE, zone information associated with the one or more second UEs including one or more zone identifiers associated with each of the one or more second UEs, a threshold communication range associated with one or both of the first RAT modem of the first UE or the second RAT modem of the first UE, or a reference signal received power (RSRP) associated with the at least one packet.

In some examples, the first RAT includes a LTE RAT, a 4G RAT, a 5G RAT, a NR access technology, a 6G RAT, or any combination thereof. In some examples, the second RAT includes a Wi-Fi RAT, a DSRC RAT, or both.

In some examples, the first RAT includes a LTE-V2X RAT, a NR-V2X RAT, or both.

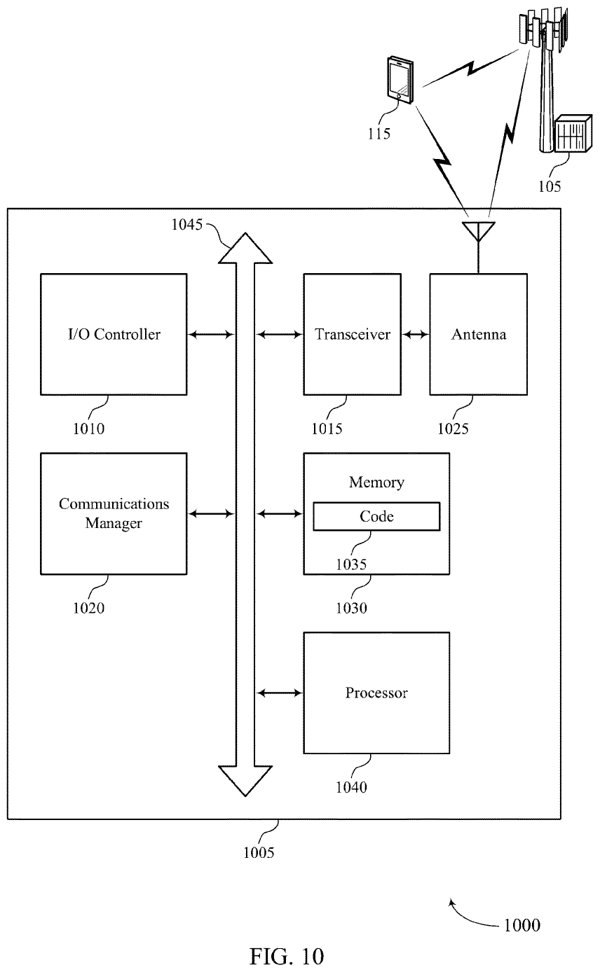

FIG. 10 illustrates a diagram of a system 1000 including a device 1005 that supports techniques for managing adjacent channel coexistence for different RATs in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for managing adjacent channel coexistence for different RATs). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE (e.g., the device 1005) in accordance with examples as disclosed herein. For example, the communications manager 1020 may be configured as or otherwise support a means for receiving, at a first RAT modem of the first UE, SCI indicative of a set of parameters and a set of time resources reserved for receipt of at least one packet from one or more second UEs via a first RAT associated with the first RAT modem of the first UE. The communications manager 1020 may be configured as or otherwise support a means for outputting, from the first RAT modem of the first UE to a second RAT modem of the first UE, information indicative of the set of parameters and the set of time resources re-serving for receipt of the at least one packet from the one or more second UEs via the first RAT associated with the first RAT modem, the second RAT modem being associated with a second RAT different from the first RAT. The communications manager 1020 may be configured as or otherwise support a means for refraining, at the first UE, from communicating using the second RAT modem of the first UE during the set of time resources based on the information indicative of the set of parameters and the set of time resources. The communications manager 1020 may be configured as or otherwise support a means for receiving, via the first RAT and using the first RAT modem, the at least one packet using one or more parameters of the set of parameters and one or more resources of the set of time resources.

By including or configuring the communications manager 1020 in accordance with examples as described herein, the device 1005 may support techniques for reduced power consumption and improved coordination between modems.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for managing adjacent channel coexistence for different RATs as described herein, or the processor 1040 and the memory 1030 may be otherwise configured to perform or support such operations.

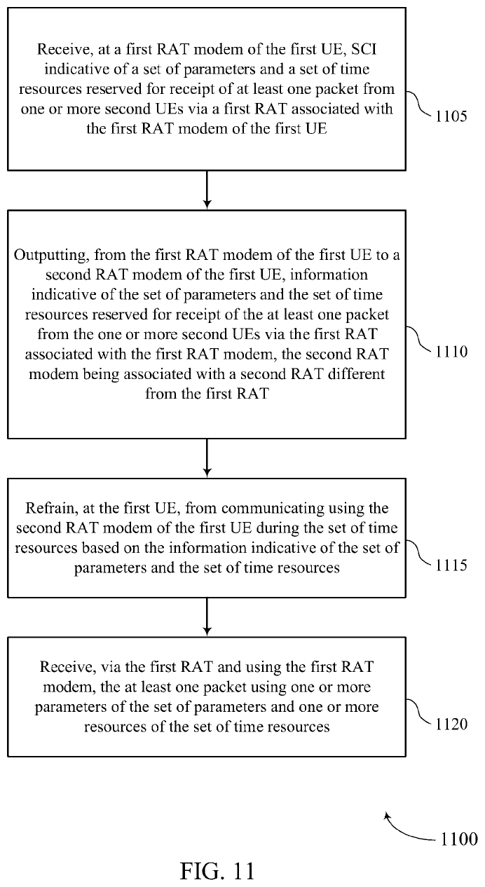

FIG. 11 illustrates a flowchart showing a method 1100 that supports techniques for managing adjacent channel coexistence for different RATs in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving, at a first RAT modem of the first UE, SCI indicative of a set of parameters and a set of time resources reserved for receipt of at least one packet from one or more second UEs via a first RAT associated with the first RAT modem of the first UE. The operations of 1105 may be performed in accordance with examples as disclosed herein. In some examples, aspects of the operations of 1105 may be performed by a first modem component 925 as described with reference to FIG. 9.

At 1110, the method may include outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT. The operations of 1110 may be performed in accordance with examples as disclosed herein. In some examples, aspects of the operations of 1110 may be performed by a first modem component 925 as described with reference to FIG. 9.

At 1115, the method may include refraining, at the first UE, from communicating using the second RAT modem of the first UE during the set of time resources based on the information indicative of the set of parameters and the set of time resources. The operations of 1115 may be performed in accordance with examples as disclosed herein. In some examples, aspects of the operations of 1115 may be performed by a second modem component 930 as described with reference to FIG. 9.

At 1120, the method may include receiving, via the first RAT and using the first RAT modem, the at least one packet using one or more parameters of the set of parameters and one or more resources of the set of time resources. The operations of 1120 may be performed in accordance with examples as disclosed herein. In some examples, aspects of the operations of 1120 may be performed by a first modem component 925 as described with reference to FIG. 9.

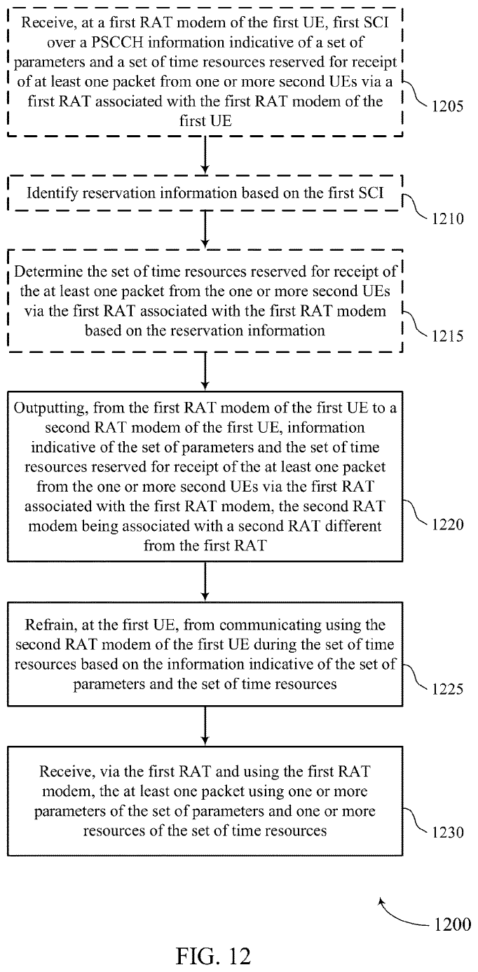

FIG. 12 illustrates a flowchart showing a method 1200 that supports techniques for managing adjacent channel coexistence for different RATs in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving, at a first RAT modem of the first UE, First SCI over a PSCCH indicative of a set of parameters and a set of time resources reserved for receipt of at least one packet from one or more second UEs via a first RAT associated with the first RAT modem of the first UE. The operations of 1205 may be performed in accordance with examples as disclosed herein. In some examples, aspects of the operations of 1205 may be performed by a first modem component 925 as described with reference to FIG. 9.

At 1210, the method may include identifying reservation information based on the first SCI. The operations of 1210 may be performed in accordance with examples as disclosed herein. In some examples, aspects of the operations of 1210 may be performed by a reservation component 950 as described with reference to FIG. 9.

At 1215, the method may include determining the set of time resources reserved for receipt of the at least one packet from the one or more second UEs via the first RAT associated with the first RAT modem based on the reservation information. The operations of 1215 may be performed in accordance with examples as disclosed herein. In some examples, aspects of the operations of 1215 may be performed by a resource component 935 as described with reference to FIG. 9.

At 1220, the method may include outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT. The operations of 1220 may be performed in accordance with examples as disclosed herein. In some examples, aspects of the operations of 1220 may be performed by a first modem component 925 as described with reference to FIG. 9.

At 1225, the method may include refraining, at the first UE, from communicating using the second RAT modem of the first UE during the set of time resources based on the information indicative of the set of parameters and the set of time resources. The operations of 1225 may be performed in accordance with examples as disclosed herein. In some examples, aspects of the operations of 1225 may be performed by a second modem component 930 as described with reference to FIG. 9.

At 1230, the method may include receiving, via the first RAT and using the first RAT modem, the at least one packet using one or more parameters of the set of parameters and one or more resources of the set of time resources. The operations of 1230 may be performed in accordance with examples as disclosed herein. In some examples, aspects of the operations of 1230 may be performed by a first modem component 925 as described with reference to FIG. 9.

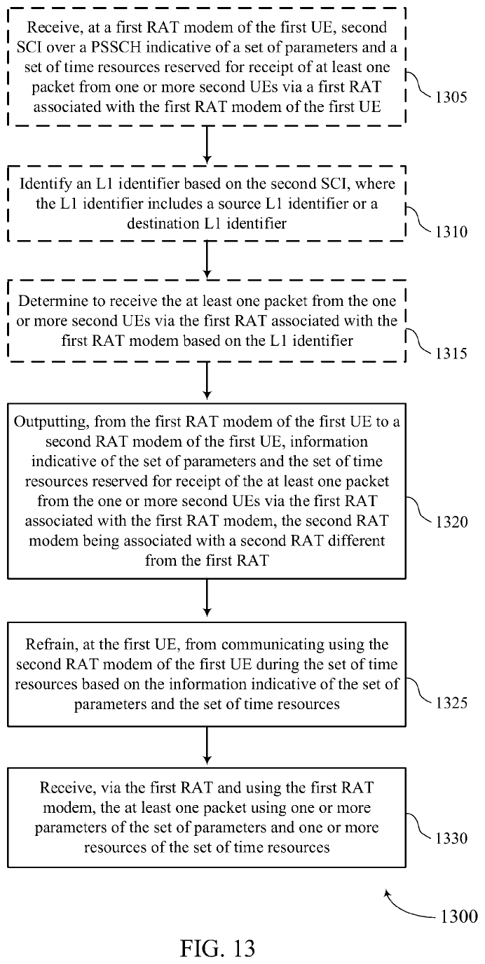

FIG. 13 illustrates a flowchart showing a method 1300 that supports techniques for managing adjacent channel coexistence for different RATs in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving, at a first RAT modem of the first UE, second SCI over a PSSCH indicative of a set of parameters and a set of time resources reserved for receipt of at least one packet from one or more second UEs via a first RAT associated with the first RAT modem of the first UE. The operations of 1305 may be performed in accordance with examples as disclosed herein. In some examples, aspects of the operations of 1305 may be performed by a first modem component 925 as described with reference to FIG. 9.

At 1310, the method may include identifying a L1 identifier based on the second SCI, where the L1 identifier includes a source L1 identifier or a destination L1 identifier. The operations of 1310 may be performed in accordance with examples as disclosed herein. In some examples, aspects of the operations of 1310 may be performed by an identifier component 955 as described with reference to FIG. 9.

At 1315, the method may include determining to receive the at least one packet from the one or more second UEs via the first RAT associated with the first RAT modem based on the L1 identifier. The operations of 1315 may be performed in accordance with examples as disclosed herein. In some examples, aspects of the operations of 1315 may be performed by a packet component 960 as described with reference to FIG. 9.

At 1320, the method may include outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT. The operations of 1320 may be performed in accordance with examples as disclosed herein. In some examples, aspects of the operations of 1320 may be performed by a first modem component 925 as described with reference to FIG. 9.

At 1325, the method may include refraining, at the first UE, from communicating using the second RAT modem of the first UE during the set of time resources based on the information indicative of the set of parameters and the set of time resources. The operations of 1325 may be performed in accordance with examples as disclosed herein. In some examples, aspects of the operations of 1325 may be performed by a second modem component 930 as described with reference to FIG. 9.

At 1330, the method may include receiving, via the first RAT and using the first RAT modem, the at least one packet using one or more parameters of the set of parameters and one or more resources of the set of time resources. The operations of 1330 may be performed in accordance with examples as disclosed herein. In some examples, aspects of the operations of 1330 may be performed by a first modem component 925 as described with reference to FIG. 9.

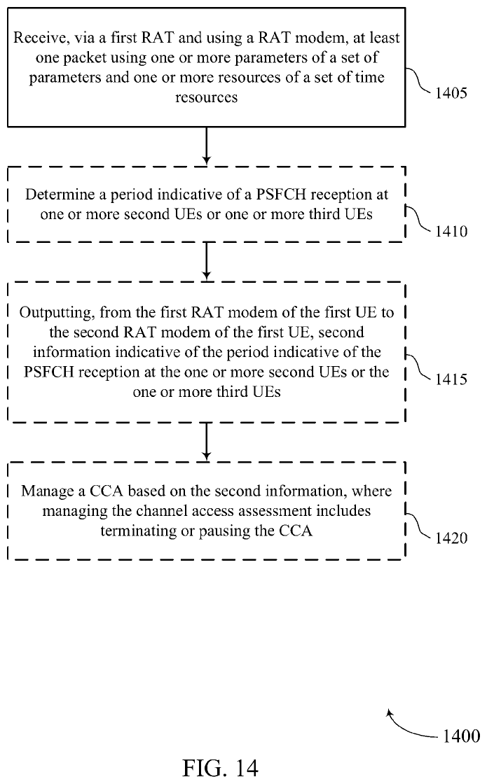

FIG. 14 illustrates a flowchart showing a method 1400 that supports techniques for managing adjacent channel coexistence for different RATs in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving, via a first RAT and using a first RAT modem, at least one packet using one or more parameters of a set of parameters and one or more resources of a set of time resources. The operations of 1405 may be performed in accordance with examples as disclosed herein. In some examples, aspects of the operations of 1405 may be performed by a resource component 935 as described with reference to FIG. 9

At 1410, the method may include determining a period indicative of a PSFCH reception at one or more second UEs or one or more third UEs. The operations of 1410 may be performed in accordance with examples as disclosed herein. In some examples, aspects of the operations of 1410 may be performed by a resource component 935 as described with reference to FIG. 9.

At 1415, the method may include outputting, from the first RAT modem of the first UE to the second RAT modem of the first UE, second information indicative of the period indicative of the PSFCH reception at the one or more second UEs or the one or more third UEs. The operations of 1415 may be performed in accordance with examples as disclosed herein. In some examples, aspects of the operations of 1415 may be performed by a first modem component 925 as described with reference to FIG. 9.

At 1420, the method may include managing a CCA based on the second information, where managing the channel access assessment includes terminating or pausing the CCA. The operations of 1420 may be performed in accordance with examples as disclosed herein. In some examples, aspects of the operations of 1420 may be performed by a channel access component 965 as described with reference to FIG. 9.

The following provides an overview of aspects of the present disclosure:

Aspect 1: A method for wireless communication at a first UE, comprising: receiving, at a first RAT modem of the first UE, SCI indicative of a set of parameters and a set of time resources reserved for receipt of at least one packet from one or more second UEs via a first RAT associated with the first RAT modem of the first UE; outputting, from the first RAT modem of the first UE to a second RAT modem of the first UE, information indicative of the set of parameters and the set of time resources reserved for receipt of the at least one packet from the one or more second UEs via the first RAT associated with the first RAT modem, the second RAT modem being associated with a second RAT different from the first RAT; refraining, at the first UE, from communicating using the second RAT modem of the first UE during the set of time resources based at least in part on the information indicative of the set of parameters and the set of time resources; and receiving, via the first RAT and using the first RAT modem, the at least one packet using one or more parameters of the set of parameters and one or more resources of the set of time resources.

Aspect 2: The method of aspect 1, wherein refraining from communicating using the second RAT modem of the first UE during the set of time resources is based at least in part on an overlap between a first time resource reserved for the first RAT associated with the first RAT modem and a second time resource reserved for the second RAT associated with the second RAT modem.

Aspect 3: The method of any of aspects 1 through 2, further comprising: determining the set of time resources reserved for receipt of the at least one packet from the one or more second UEs via the first RAT associated with the first RAT modem based at least in part on the SCI.

Aspect 4: The method of any of aspects 1 through 3, further comprising: generating a data structure indicative of the set of time resources reserved for receipt of the at least one packet from the one or more second UEs via the first RAT associated with the first RAT modem, wherein the information indicative of the set of time resources comprises the data structure.

Aspect 5: The method of any of aspects 1 through 4, wherein the SCI comprises first SCI or second SCI, and outputting the information indicative of the set of time resources reserved for receipt of the at least one packet from the one or more second UEs via the first RAT associated with the first RAT modem is based at least in part on one of the first SCI or the second SCI.

Aspect 6: The method of any of aspects 1 through 5, wherein receiving the SCI comprises: receiving first SCI over a physical sidelink control channel, the method further comprising: identifying reservation information based at least in part on the first SCI; and determining the set of time resources reserved for receipt of the at least one packet from the one or more second UEs via the first RAT associated with the first RAT modem based at least in part on the reservation information.

Aspect 7: The method of any of aspects 1 through 6, further comprising: receiving second SCI over a physical sidelink shared channel; identifying a layer one identifier based at least in part on the second SCI, wherein the layer one identifier comprises a source layer one identifier or a destination layer one identifier; and determining to receive the at least one packet from the one or more second UEs via the first RAT associated with the first RAT modem based at least in part on the layer one identifier.

Aspect 8: The method of any of aspects 1 through 7, further comprising: determining a period indicative of a physical sidelink feedback channel reception at the one or more second UEs or one or more third UEs; outputting, from the first RAT modem of the first UE to the second RAT modem of the first UE, second information indicative of the period indicative of the physical sidelink feedback channel reception at the one or more second UEs or the one or more third UEs; and managing a channel access assessment based at least in part on the second information, wherein managing the channel access assessment comprises terminating or pausing the channel access assessment.

Aspect 9: The method of aspect 8, further comprising: identifying the one or more second UEs or the one or more third UEs based at least in part on zone information indicating one or more zones associated with the one or more second UEs or the one or more third UEs.

Aspect 10: The method of any of aspects 1 through 9, further comprising: determining a pending physical sidelink feedback channel reception at the first UE based at least in part on one of first SCI or second SCI; and managing a channel access assessment based at least in part on the pending physical sidelink feedback channel reception, wherein managing the channel access assessment comprises terminating or pausing the channel access assessment.

Aspect 11: The method of any of aspects 1 through 10, further comprising: determining a priority associated with the at least one packet; and determining the set of time resources reserved for receipt of the at least one packet from the one or more second UEs via the first RAT associated with the first RAT modem based at least in part on the priority associated with the at least one packet, and wherein the set of time resources is based at least in part on the priority associated with the at least one packet satisfying a threshold.

Aspect 12: The method of aspect 11, wherein the SCI comprises first SCI indicating the priority associated with the at least one packet.

Aspect 13: The method of any of aspects 1 through 12, further comprising: measuring a reference signal received power value associated with the at least one packet; and determining the set of time resources reserved for receipt of the at least one packet from the one or more second UEs via the first RAT associated with the first RAT modem based at least in part on the reference signal received power value associated with the at least one packet.

Aspect 14: The method of any of aspects 1 through 13, further comprising: transmitting feedback associated with the at least one packet based at least in part on a decoding result associated with the at least one packet; and determining a second set of time resources reserved for receipt of the at least one packet from the one or more second UEs via the first RAT associated with the first RAT modem based at least in part on the decoding result associated with the at least one packet.

Aspect 15: The method of any of aspects 1 through 14, wherein the information comprises a command for the second RAT modem of the first UE to pause performing a channel access assessment for a duration of time based at least in part on a priority associated with the at least one packet.

Aspect 16: The method of any of aspects 1 through 15, wherein the information comprises a command for the second RAT modem of the first UE to terminate a channel access assessment based at least in part on a priority associated with the at least one packet.

Aspect 17: The method of any of aspects 1 through 16, wherein the information indicative of the set of time resources reserved for receipt of the at least one packet from the one or more second UEs via the first RAT associated with the first RAT modem is further indicative of one or more time resources reserved for receipt of a sidelink feedback message over a physical sidelink feedback channel via the first RAT associated with the first RAT modem.

Aspect 18: The method of aspect 17, wherein the information indicative of the set of time resources reserved for receipt of the at least one packet from the one or more second UEs via the first RAT associated with the first RAT modem is further indicative of a feedback mode associated with the first UE.

Aspect 19: The method of any of aspects 1 through 18, further comprising: receiving an inter-UE coordination message comprising second information indicative of a second set of time resources reserved by at least one second UE of the one or more second UEs; outputting, from the first RAT modem of the first UE to the second RAT modem of the first UE, third information indicative of the second set of time resources reserved by the at least one second UE of the one or more second UEs; and managing a channel access assessment based at least in part on the third information, wherein managing the channel access assessment comprises terminating or pausing the channel access assessment.

Aspect 20: The method of aspect 19, further comprising: measuring a reference signal received power value associated with the inter-UE coordination message, wherein outputting, from the first RAT modem of the first UE to the second RAT modem of the first UE, the third information indicative of the second set of time resources reserved by the at least one second UE of the one or more second UEs is based at least in part on the reference signal received power value associated with the inter-UE coordination message satisfying a threshold.

Aspect 21: The method of any of aspects 1 through 20, wherein the set of time resources comprises one or more slots.

Aspect 22: The method of any of aspects 1 through 21, wherein the set of parameters comprises one or more of a priority associated with the at least one packet, a physical layer configuration associated with one or both of the first RAT modem of the first UE or the second RAT modem of the first UE, zone information associated with the one or more second UEs including one or more zone identifiers associated with each of the one or more second UEs, a threshold communication range associated with one or both of the first RAT modem of the first UE or the second RAT modem of the first UE, or a reference signal received power (RSRP) associated with the at least one packet.

Aspect 23: The method of any of aspects 1 through 22, wherein the first RAT comprises a LTE RAT, a 4G RAT, a 5G RAT, a NR access technology, a 6G RAT, or any combination thereof, and the second RAT comprises a Wi-Fi RAT, a DSRC RAT, or both.

Aspect 24: The method of any of aspects 1 through 23, wherein the first RAT comprises a LTE-V2X RAT, a NR-V2X RAT, or both.

Aspect 25: An apparatus for wireless communication at a first UE, comprising a processor; and memory coupled with the processor, the processor configured to perform a method of any of aspects 1 through 24.

Aspect 26: An apparatus for wireless communication at a first UE, comprising at least one means for performing a method of any of aspects 1 through 24.

Aspect 27: A non-transitory computer-readable medium storing code for wireless communication at a first UE, the code comprising instructions executable by a processor to perform a method of any of aspects 1 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
a processor; and
memory coupled with the processor, the processor configured to:
receive, at a first radio access technology modem of the first UE, sidelink control information indicative of a set of parameters and a set of time resources reserved for receipt of at least one packet from one or more second UEs via a first radio access technology associated with the first radio access technology modem of the first UE;
output, from the first radio access technology modem of the first UE to a second radio access technology modem of the first UE, information indicative of the set of parameters and the set of time resources reserved for receipt of the at least one packet from the one or more second UEs via the first radio access technology associated with the first radio access technology modem, the second radio access technology modem being associated with a second radio access technology different from the first radio access technology;
refrain, at the first UE, from communicating using the second radio access technology modem of the first UE during the set of time resources based at least in part on the information indicative of the set of parameters and the set of time resources; and
receive, via the first radio access technology and using the first radio access technology modem, the at least one packet using one or more parameters of the set of parameters and one or more resources of the set of time resources.

2. The apparatus of claim 1, wherein to refrain from the communication using the second radio access technology modem of the first UE during the set of time resources is based at least in part on an overlap between a first time resource reserved for the first radio access technology associated with the first radio access technology modem and a second time resource reserved for the second radio access technology associated with the second radio access technology modem.

3. The apparatus of claim 1, wherein the processor is further configured to:
determine the set of time resources reserved for receipt of the at least one packet from the one or more second UEs via the first radio access technology associated with the first radio access technology modem based at least in part on the sidelink control information.

4. The apparatus of claim 1, wherein the processor is further configured to:
generate a data structure indicative of the set of time resources reserved for receipt of the at least one packet from the one or more second UEs via the first radio access technology associated with the first radio access technology modem, wherein the information indicative of the set of time resources comprises the data structure.

5. The apparatus of claim 1, wherein the sidelink control information comprises first sidelink control information or second sidelink control information, and wherein the processor is configured to output the information indicative of the set of time resources reserved for receipt of the at least one packet from the one or more second UEs via the first radio access technology associated with the first radio access technology modem based at least in part on one of the first sidelink control information or the second sidelink control information.

6. The apparatus of claim 1, wherein, to receive the sidelink control information, the processor is configured to:
receive first sidelink control information over a physical sidelink control channel, wherein the processor is further configured to:
identify reservation information based at least in part on the first sidelink control information; and
determine the set of time resources reserved for receipt of the at least one packet from the one or more second UEs via the first radio access technology associated with the first radio access technology modem based at least in part on the reservation information.

7. The apparatus of claim 1, wherein the processor is further configured to:
receive second sidelink control information over a physical sidelink shared channel;
identify a layer one identifier based at least in part on the second sidelink control information, wherein the layer one identifier comprises a source layer one identifier or a destination layer one identifier; and
determine to receive the at least one packet from the one or more second UEs via the first radio access technology associated with the first radio access technology modem based at least in part on the layer one identifier.

8. The apparatus of claim 1, wherein the processor is further configured to:
determine a period indicative of a physical sidelink feedback channel reception at the one or more second UEs or one or more third UEs;
output, from the first radio access technology modem of the first UE to the second radio access technology modem of the first UE, second information indicative of the period indicative of the physical sidelink feedback channel reception at the one or more second UEs or the one or more third UEs; and
manage a channel access assessment based at least in part on the second information,
wherein, to manage the channel access assessment, the processor is configured to terminate or pause the channel access assessment.

9. (canceled)

10. The apparatus of claim 1, wherein the processor is further configured to:
determine a pending physical sidelink feedback channel reception at the first UE based at least in part on one of first sidelink control information or second sidelink control information; and
manage a channel access assessment based at least in part on the pending physical sidelink feedback channel reception,
wherein, to manage the channel access assessment, the processor is configured to terminate or pause the channel access assessment.

11. The apparatus of claim 1, wherein the processor is further configured to:
determine a priority associated with the at least one packet; and
determine the set of time resources reserved for receipt of the at least one packet from the one or more second UEs via the first radio access technology associated with the first radio access technology modem based at least in part on the priority associated with the at least one packet, and wherein the set of time resources is based at least in part on the priority associated with the at least one packet satisfying a threshold.

12. The apparatus of claim 11, wherein the sidelink control information comprises first sidelink control information indicating the priority associated with the at least one packet.

13. The apparatus of claim 1, wherein the processor is further configured to:
measure a reference signal received power value associated with the at least one packet; and
determine the set of time resources reserved for receipt of the at least one packet from the one or more second UEs via the first radio access technology associated with the first radio access technology modem based at least in part on the reference signal received power value associated with the at least one packet.

14. The apparatus of claim 1, wherein the processor is further configured to:
transmit feedback associated with the at least one packet based at least in part on a decoding result associated with the at least one packet; and
determine a second set of time resources reserved for receipt of the at least one packet from the one or more second UEs via the first radio access technology associated with the first radio access technology modem based at least in part on the decoding result associated with the at least one packet.

15. The apparatus of claim 1, wherein the information comprises a command for the second radio access technology modem of the first UE to pause performing a channel access assessment for a duration of time based at least in part on a priority associated with the at least one packet.

16. The apparatus of claim 1, wherein the information comprises a command for the second radio access technology modem of the first UE to terminate a channel access assessment based at least in part on a priority associated with the at least one packet.

17. The apparatus of claim 1, wherein the information indicative of the set of time resources reserved for receipt of the at least one packet from the one or more second UEs via the first radio access technology associated with the first radio access technology modem is further indicative of one or more time resources reserved for receipt of a sidelink feedback message over a physical sidelink feedback channel via the first radio access technology associated with the first radio access technology modem.

18. (canceled)

19. The apparatus of claim 1, wherein the processor is further configured to:
receive an inter-UE coordination message comprising second information indicative of a second set of time resources reserved by at least one second UE of the one or more second UEs;
output, from the first radio access technology modem of the first UE to the second radio access technology modem of the first UE, third information indicative of the second set of time resources reserved by the at least one second UE of the one or more second UEs; and
manage a channel access assessment based at least in part on the third information,
wherein, to manage the channel access assessment, the processor is configured to terminate or pause the channel access assessment.

20. (canceled)

21. (canceled)

22. The apparatus of claim 1, wherein the set of parameters comprises one or more of a priority associated with the at least one packet, a physical layer configuration associated with one or both of the first radio access technology modem of the first UE or the second radio access technology modem of the first UE, zone information associated with the one or more second UEs including one or more zone identifiers associated with each of the one or more second UEs, a threshold communication range associated with one or both of the first radio access technology modem of the first UE or the second radio access technology modem of the first UE, or a reference signal received power (RSRP) associated with the at least one packet.

23. (canceled)

24. (canceled)

25. A method for wireless communication at a first user equipment (UE), comprising:
receiving, at a first radio access technology modem of the first UE, sidelink control information indicative of a set of parameters and a set of time resources reserved for receipt of at least one packet from one or more second UEs via a first radio access technology associated with the first radio access technology modem of the first UE;
outputting, from the first radio access technology modem of the first UE to a second radio access technology modem of the first UE, information indicative of the set of parameters and the set of time resources reserved for receipt of the at least one packet from the one or more second UEs via the first radio access technology associated with the first radio access technology modem, the second radio access technology modem associated with a second radio access technology different from the first radio access technology;
refraining, at the first UE, from communication via the second radio access technology modem of the first UE on the set of time resources based at least in part on the information indicative of the set of parameters and the set of time resources; and
receiving, via the first radio access technology and the first radio access technology modem, the at least one packet based at least in part on one or more parameters of the set of parameters and one or more resources of the set of time resources.

26. The method of claim 25, wherein refraining from the communication via the second radio access technology modem of the first UE on the set of time resources is based at least in part on an overlap between a first time resource reserved for the first radio access technology associated with the first radio access technology modem and a second time resource reserved for the second radio access technology associated with the second radio access technology modem.

27.-30. (canceled)
